(19) United States
(12) Patent Application Publication
(10) Pub. No.: US 2018/0065558 A1
(43) Pub. Date: Mar. 8, 2018

(54) MIRROR, IN-VEHICLE OPERATION DEVICE, AND VEHICLE

(71) Applicant: SHARP KABUSHIKI KAISHA, Sakai City, Osaka (JP)

(72) Inventors: SATORU MATSUYAMA, Kitakatsuragi-Country, Nara (JP); YOSHIMITSU INAMORI, Sakai City (JP); KEISAKU NAKAGAWA, Sakai City (JP); MITSUO UENO, Utsunomiya-City, Tochigi (JP); JUMPEI NISHIMURA, Kobe-City, Hyogo (JP)

(21) Appl. No.: 15/557,056

(22) PCT Filed: Mar. 1, 2016
(86) PCT No.: PCT/JP2016/056291

§ 371 Date: Sep. 8, 2017

(30) Foreign Application Priority Data
Mar. 9, 2015 (JP) 2015-046092
Dec. 17, 2015 (JP) 2015-246753

(51) Int. Cl. B60R 1/12; B60R 16/02; B60R 1/08; B60R 1/04

(52) U.S. Cl. CPC B60R 1/12; B60R 16/02; B60R 2001/1215; B60R 1/04; B60R 1/08

(57) ABSTRACT

To ensure the safety of the driver and offer an improved operability at the same time, a rear-view mirror (200) includes a half mirror (150) configured to reflect light incident on its reflecting surface and transmit light incident on its transmitting surface and a side-surface touch sensor (121) configured to detect a touch by the user on the side surface of a casing that houses a display (130) having a display surface and disposed on or over the half mirror (150) in such a manner that the transmitting surface faces the display surface.

### TECHNICAL FIELD

The present invention relates to, for example, a mirror and an in-vehicle device.

### BACKGROUND ART

An operation device has been known that includes a casing and a contact sensor on a side surface of the casing to detect a touch on the side surface of the casing. Patent Literature 1 below, for example, discloses an image display device that includes a touch input section in the shape of a line on a side surface of the image display device which side surface includes a corner of the casing of a display section and that carries out a process on the basis of information on a position detected by the touch input section. Patent Literature 2 discloses an electronic device including (i) a touch panel and (ii) a contact sensor on each of the four side surfaces of the electronic device that are adjacent to the surface on which the touch panel is disposed.

Further, as disclosed in Patent Literatures 3 and 4 below, there has been known a technique for displaying an image on a mirror (rear-view mirror) mounted in a vehicle. Patent Literature 3 discloses a rear-view mirror including a half mirror as its mirror section and a monitor contained in a casing. Patent Literature 4 discloses a rear-view mirror monitor configured to display an image in conjunction with a navigation device.

### CITATION LIST

### Patent Literature

[Patent Literature 1]

Japanese Patent Application Publication Tokukai No. 2010-245843 (Publication date: Oct. 28, 2010)

[Patent Literature 2]

Japanese Patent Publication for Patent No. 5665601 (Registration date: Dec. 19, 2014).

[Patent Literature 3]

Japanese Patent Application Publication Tokukaihei No. 11-78693 (Publication date: Mar. 23, 1999)

[Patent Literature 4]

Japanese Patent Application Publication Tokukai No. 2015-148468 (Publication date: Aug. 20, 2015)

[Patent Literature 5]

Japanese Patent Application Publication Tokukai No. 2002-187492 (Publication date: Jul. 2, 2002)

[Patent Literature 6]

Japanese Patent Application Publication Tokukai No. 2014-123197 (Publication date: Jul. 3, 2014)

### SUMMARY OF INVENTION

### Technical Problem

The above Patent Literatures do not disclose a technical idea of equipping a vehicle with an operation device such as the above or incorporating an operation device such as the above in a rear-view mirror. In a case where a vehicle is equipped with such an operation device, it is necessary to ensure the safety of the driver who operates the operation device.

The operation devices disclosed respectively in Patent Literatures 1 and 2 each include a casing in the shape of a rectangular, flat plate and a contact sensor on a side surface of the casing. In a case where an operator has touched the side surface of the casing without looking at the casing, it is difficult for the operator to know which position on the side surface of the casing the operator has touched. Specifically, an operator has the same feel when touching one position on a side surface of a casing in the shape of a rectangular, flat plate and when touching another position over the side surface (see FIG. 18). It is extremely difficult for the operator to know without looking at the casing which position on the side surface of the casing the operator has touched.

FIG. 18 is a diagram illustrating an example operation on a conventional input device 999 configured to detect a touch on a side surface of the casing. The input device 999 includes a rectangular display 997, a casing in the shape of a rectangular, flat plate which casing houses the display 997, and a side-surface touch sensor 998 on a side surface of the casing. The feel experienced by the user differs little between a case where the user has touched a point X on the side surface of the casing on which side surface the side-surface touch sensor 998 disposed, a case where the user has touched a point Y on the side surface, and a case where the user has touched a point Z on the side surface. This makes it difficult for the user to know without looking at the input device 999 which position on the side surface of the input device 999 the user has touched, for example, whether the user has touched the point X, the point Y, or the point Z. This means that the conventional input device 999 assumes that the user touches a predetermined position on the side-surface touch sensor 998 (for example, the point X) while looking at the input device 999. It is difficult for the user to know without looking at the input device 999 that for instance, the user has touched the point X, not the point Y or the point Z.

In a case where a driver wants to operate an in-vehicle operation device while driving the vehicle, the driver is unable to look at the in-vehicle operation device or is only able to look at it for an extremely short time period. This means that in a case where the in-vehicle operation device includes a casing in the shape of a rectangular, flat plate and a contact sensor on a side surface of the casing, it is extremely difficult for the driver while driving the vehicle to intentionally touch a predetermined position on a side surface of the in-vehicle operation device for an associated operation.

A rear-view mirror has been known that includes a physical button to accept a user's input. This configuration, however, results in a larger mirror, which unfortunately makes it less easy for a driver to look ahead. The driver also needs to not only touch the physical button, but also press it down. Such a rear-view mirror is not easy to operate. A rear-view mirror may be provided with a touch panel on a surface of the mirror. Fingerprints and/or the like will, however, make the mirror dirty, with the result of decreased visibility.

As described above, conventional art fails to sufficiently ensure the safety of the driver and offer an improved operability at the same time.

The present invention has been accomplished in view of the above issue. It is an object of the present invention to provide, for example, a mirror and an in-vehicle operation device each of which ensures the safety of the driver and offers an improved operability at the same time.

### Solution to Problem

In order to attain the above object, a mirror in accordance with an aspect of the present invention includes: a half mirror section having a reflecting surface and a transmitting surface and configured to reflect light incident on the reflecting surface and transmit light incident on the transmitting surface; a display section configured to display an image, the display section having a display surface and being disposed on or over the half mirror section in such a manner that the transmitting surface faces the display surface; a casing to which the half mirror section and the display section are assembled, the casing having a side surface extending along a periphery of the half mirror section and a periphery of the display section; and a side-surface touch detecting section configured to detect a touch by a user on the side surface of the casing.

In order to attain the above object, an in-vehicle operation device in accordance with an aspect of the present invention includes: a display screen having a curved portion or cutout portion on a periphery thereof; a casing to which the display screen is assembled, the casing having a side surface along the periphery of the display screen, the side surface extending in a direction of depth of the display screen; and at least one side-surface touch detecting section configured to detect a touch by a user on at least a position on a portion of the side surface of the casing which portion extends along the curved portion or cutout portion of the display screen.

### Advantageous Effects of Invention

An aspect of the present invention ensures the safety of the driver and offers an improved operability at the same time.

### BRIEF DESCRIPTION OF DRAWINGS

FIG. 1 is a block diagram illustrating an example configuration of main sections of a rear-view mirror in accordance with Embodiment 1 of the present invention.

FIG. 2 shows diagrams illustrating an outline of the rear-view mirror illustrated in FIG. 1. (a) of FIG. 2 is a diagram schematically illustrating how the rear-view mirror illustrated in FIG. 1 is mounted in a vehicle. (b) of FIG. 2 is a diagram schematically illustrating the appearance of the rear-view mirror illustrated in FIG. 1.

FIG. 3 shows transition diagrams illustrating an example picture seen on the mirror surface of the rear-view mirror illustrated in FIG. 1.

FIG. 4 shows diagrams illustrating an example of sensor electrodes disposed on the casing of the rear-view mirror illustrated in FIG. 1.

FIG. 5 is a block diagram illustrating an example configuration of main sections of a rear-view mirror in accordance with each of Embodiments 2 and 3 of the present invention.

FIG. 6 shows transition diagrams illustrating an example picture seen on the mirror surface of the rear-view mirror illustrated in FIG. 5.

FIG. 7 shows transition diagrams illustrating another example picture seen on the mirror surface of the rear-view mirror illustrated in FIG. 5.

FIG. 8 is a block diagram illustrating an example configuration of main sections of an in-vehicle operation device in accordance with Embodiment 4 of the present invention.

FIG. 9 shows diagrams illustrating an outline of the in-vehicle operation device illustrated in FIG. 8. (a) of FIG. 9 is a diagram schematically illustrating how the in-vehicle operation device illustrated in FIG. 8 is mounted in a vehicle. (b) of FIG. 9 is a diagram schematically illustrating the appearance of the in-vehicle operation device illustrated in FIG. 8.

FIG. 10 shows diagrams illustrating example operations on the in-vehicle operation device illustrated in FIG. 8. (a) of FIG. 10 is a diagram illustrating an operation of sliding a finger touching a side-surface touch sensor of the in-vehicle operation device illustrated in FIG. 8. (b) of FIG. 10 is a diagram illustrating how the feel that the user experiences varies according to the position of a touch on a side-surface touch sensor of the in-vehicle operation device illustrated in FIG. 8.

FIG. 11 is a diagram illustrating an example image displayed by a display of the in-vehicle operation device illustrated in FIG. 8.

FIG. 12 shows diagrams each illustrating an example of the shape of the display of the in-vehicle operation device illustrated in FIG. 8.

FIG. 13 shows diagrams illustrating example operations on an in-vehicle operation device including a substantially semicircular display.

FIG. 14 shows diagrams illustrating other example operations on an in-vehicle operation device including a substantially semicircular display.

FIG. 15 shows diagrams illustrating an example of sensor electrodes disposed on the casing of the in-vehicle operation device illustrated in FIG. 8.

FIG. 16 is a block diagram illustrating an example configuration of main sections of an in-vehicle operation device in accordance with Embodiment 5 of the present invention.

FIG. 17 is a block diagram illustrating an example configuration of main sections of an in-vehicle operation device in accordance with Embodiment 6 of the present invention.

FIG. 18 is a diagram illustrating an example operation on a conventional operation device configured to detect a touch on a side surface of the casing.

### DESCRIPTION OF EMBODIMENTS

### Embodiment 1

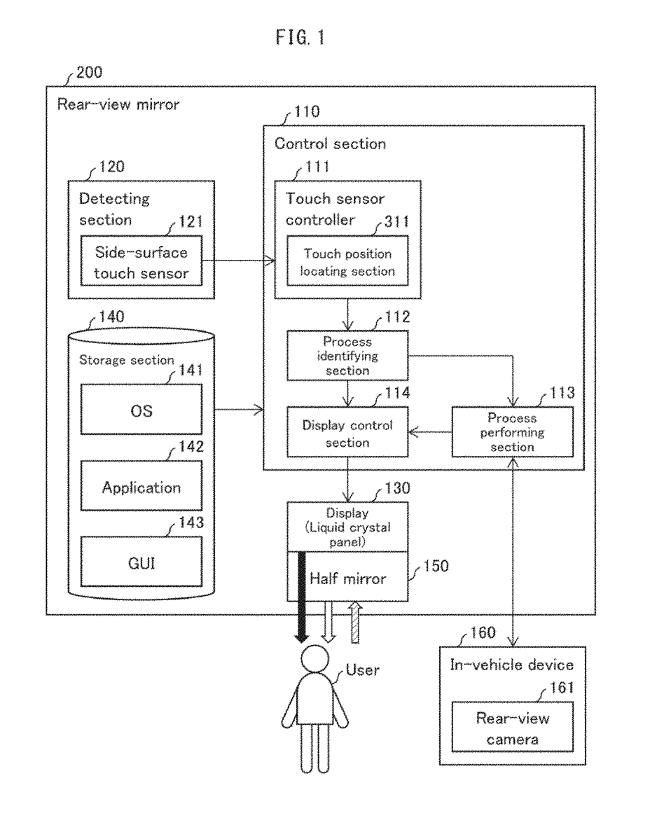

The following description will discuss an embodiment of the present invention with reference to FIGS. 1 to 4. In the description below, any member of a particular embodiment that is identical in function to a member of another embodiment described earlier is assigned a common reference sign, and may not be described for that particular embodiment for convenience of explanation.

Embodiments 1 to 3 described hereafter of the present invention are each an example rear-view mirror (driving mirror) mounted in a vehicle. The present invention is, however, not necessarily applied to a rear-view mirror; the present invention may also be applied to, for example, a mirror in a washroom or a compact, portable mirror.

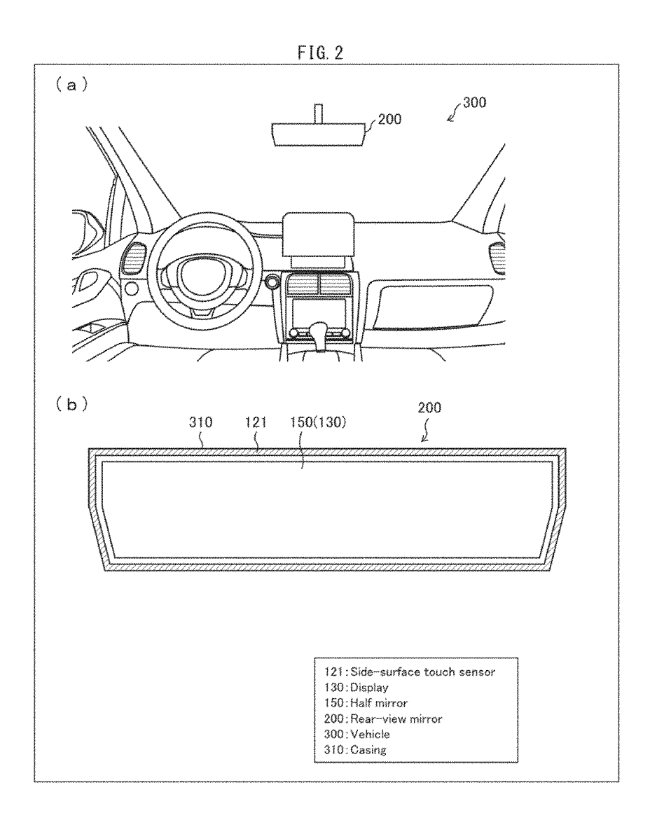

To facilitate understanding of a rear-view mirror 200 in accordance with the present embodiment, the description below first deals with an outline of the rear-view mirror 200 with reference to FIG. 2.

(Outline of Rear-View Mirror 200)

FIG. 2 shows diagrams illustrating an outline of the rear-view mirror 200. (a) of FIG. 2 is a diagram schematically illustrating how the rear-view mirror 200 is mounted in a vehicle 300. (b) of FIG. 2 is a diagram schematically illustrating the appearance of the rear-view mirror 200. As illustrated in (a) of FIG. 2, the rear-view mirror 200 is, as with a typical rear-view mirror, positioned so as to allow a person sitting in the driver's seat (hereinafter referred to also as “driver”) of the vehicle 300 to look in the rear-view mirror 200 in order to check the view behind the vehicle 300.

As illustrated in (b) of FIG. 2, the rear-view mirror 200 includes a half mirror 150 (half mirror section) and a display 130 (display section) placed on top of each other. The half mirror 150 is a mirror that reflects light incident on its reflecting surface and that transmits light incident on its transmitting surface. The display 130 is a display device configured to display an image. The term “image” as used herein covers both a still image and a moving image. The display 130 is placed on the half mirror 150 such that the display surface for displaying an image faces the transmitting surface of the half mirror 150. With this configuration, in a case where an image has been displayed on the display surface of the display 130, the half mirror 150 allows the light emitted by the display 130 to pass through, thereby allowing the image to be seen on a surface of the half mirror 150 (hereinafter referred to as “mirror surface”).

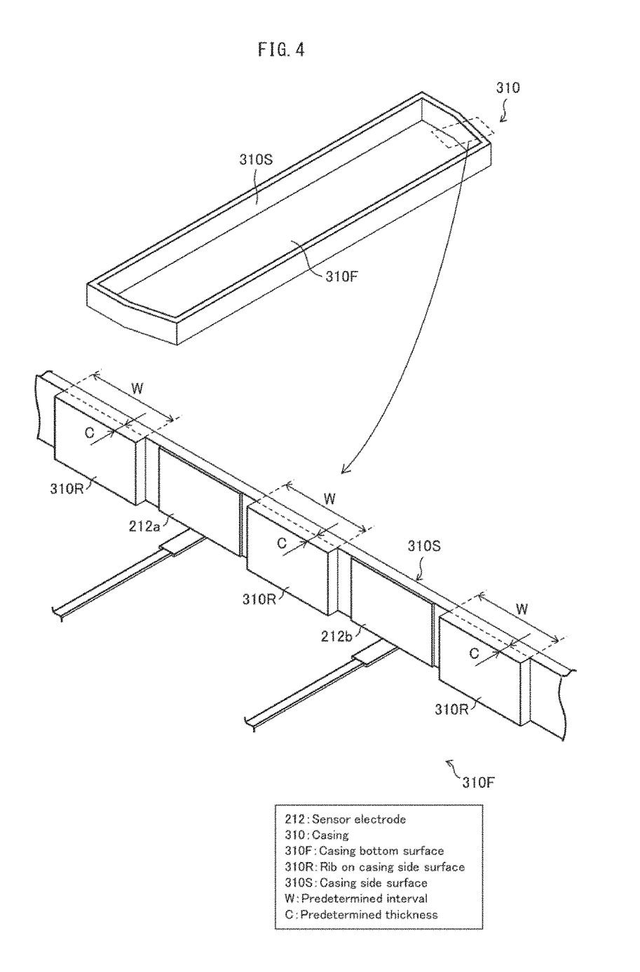

As illustrated in (b) of FIG. 2, the rear-view mirror 200 is configured such that the half mirror 150 and the display 130 are assembled to a casing 310. The casing 310 has a casing side surface (corresponding to the casing side surface 310S in FIG. 4) along the respective peripheries of the half mirror 150 and the display 130 which casing side surface extends in the direction of the respective depths of the half mirror 150 and the display 130 (that is, the direction in which FIG. 2 is viewed). As illustrated in (b) of FIG. 2, the rear-view mirror 200 further includes a side-surface touch sensor 121 (side-surface touch detecting section) extending on the entire casing side surface along the periphery of the casing 310. The side-surface touch sensor 121 detects a user's touch (technically a contact or approach) on the casing side surface.

The rear-view mirror 200, in other words, accepts an input by the user to a side surface of the casing 310 through the side-surface touch sensor 121. The rear-view mirror 200 then carries out a predetermined process associated with the input. The present embodiment assumes that the predetermined process is of obtaining, from a rear-view camera 161 (described later) mounted in the vehicle 300 and configured to capture a view behind the vehicle 300, data on a moving image captured by the rear-view camera 161. The predetermined process may be any process for controlling the rear-view mirror 200 itself or a device communicably connected to the rear-view mirror 200, and is not limited to the above example. The term “communication” as used herein covers both cable communication and radio communication. Thus, the rear-view mirror 200 and a device to be controlled may be connected to each other with use of an in-vehicle line in such a manner that allows cable communication or without use of an in-vehicle line, that is, with use of a communication means such as Wi-Fi (registered trademark) in such a manner that allows radio communication.

With the above configuration, the rear-view mirror 200 includes a casing 310 and a side-surface touch sensor 121 that is disposed on a side surface of the casing 310 and that is configured to accept an input operation by the user. The rear-view mirror 200 thus has a thin frame portion as compared to a conventional rear-view mirror including a physical button as an input device. The thin frame portion prevents the rear-view mirror from blocking the sight of the user's and allows the user to drive safely. The above configuration also allows the user to simply touch a side surface of the casing 310 for a desired process to be carried out. The user can, for example, instruct the rear-view mirror 200 to obtain data on a moving image captured of a view behind the vehicle 300 and cause the display 130 to display the moving image. The above configuration thus allows a process desired by the user to be carried out without decreasing the driving safety.

The shape of the rear-view mirror 200 is not limited to that illustrated in FIG. 2 as an example, and may be a quadrangle, for example. The rear-view mirror 200 is preferably so shaped as to allow the user to know a touch position without looking at the touch position (see the left and right side surfaces in FIG. 2). An example of such a shape is, other than the shape illustrated in FIG. 2, a shape having at least either a cutout or a curved portion. Such a cutout and a curved portion will be described later in detail for Embodiments 4 to 6.

The description above has outlined how the rear-view mirror 200 is mounted in a vehicle 300 and the appearance of the rear-view mirror 200 with reference to FIG. 2. The following description will discuss the rear-view mirror 200 in greater detail with reference to FIG. 1.

(Detailed Configuration of Rear-View Mirror 200)

FIG. 1 is a block diagram illustrating an example configuration of main sections of the rear-view mirror 200. As illustrated in FIG. 1, the rear-view mirror 200 includes a control section 110, a detecting section 120, a display 130, a storage section 140, and a half mirror 150. The description below assumes that the rear-view mirror 200 is (i) turned on when the engine of the vehicle 300 is started and is (ii) turned off when the engine of the vehicle 300 is stopped. The rear-view mirror 200 may alternatively include, on the casing 310 housing the display 130 and the half mirror 150, a component such as a power source button (power switch) for turning the rear-view mirror 200 on and off. Such a power source button or the like is not shown in FIG. 1, as it is not directly related to any feature of the present invention.

The display 130 includes, for example, a liquid crystal panel for a display surface (display panel), and displays an image on the display surface. The display panel included in the display 130 is not limited to a liquid crystal panel, and may be an organic electroluminescent (EL) panel, an inorganic EL panel, a plasma panel, or the like.

The half mirror 150 is positioned on or over the display surface so as to have a transmitting surface that faces the display surface of the display 130. While an image is displayed on the display surface of the display 130, the half mirror 150 allows light of that image to pass through, so that the image is shown on the mirror surface. The half mirror 150 has a reflecting surface that reflects external light incident thereon. This allows the driver (hereinafter referred to as “user”) of the vehicle 300 to recognize the situation behind the vehicle 300. The above configuration allows the user to receive (i) transmitted light, that is, light that was emitted from the display surface and that has passed through the half mirror 150, and (ii) reflected light, that is, light that was incident on the half mirror 150 and that has been reflected by the half mirror 150. The user is thus able to recognize at least one of an image displayed on the display surface and a mirror image shown on the half mirror 150. FIG. 1 shows a solid block arrow to indicate transmitted light, a hatched block arrow to indicate incident light, and a hollow block arrow to indicate reflected light.

The detecting section 120 includes a side-surface touch sensor 121 on a side surface of the casing 310. The side-surface touch sensor 121 detects a contact with (or an approach to; touch on) the casing 310.

The side-surface touch sensor 121 includes, for example, a plurality of capacitive sensors arranged in a line on a side surface of the casing 310. The side-surface touch sensor 121 is, however, not limited to such a configuration. The side-surface touch sensor 121 may alternatively be, for example, a sensor of a resistor film type, an infrared type, an ultrasonic type, or an electromagnetic induction coupling type. The side-surface touch sensor 121 will be described later in detail with reference to FIG. 4. The form of the side-surface touch sensor 121 is not limited to that illustrated in (b) of FIG. 2 as an example. Specifically, the side-surface touch sensor 121 may have any form as long as it is capable of detecting a touch on the casing 310 of the rear-view mirror 200.

The control section 110 centrally controls the individual sections included in the rear-view mirror 200. The control section 110 illustrated in FIG. 1 includes, as functional blocks, a touch sensor controller 111, a process identifying section 112, a process performing section 113 (obtaining section), and a display control section 114. The above functional blocks of the control section 110 can each be realized by, for instance, a central processing unit (CPU) or the like reading a program from a storage device including a read only memory (ROM), a non-volatile random access memory (NVRAM), or the like to a random access memory (RAM) or the like (not shown) and executing the program. The description below deals with the individual functional blocks of the control section 110 in detail.

The touch sensor controller 111 includes a touch position locating section 311, and on the basis of the result of the side-surface touch sensor 121 detecting a contact by an object with the side-surface touch sensor 121, locates the position of the contact by the object with the side-surface touch sensor 121. The touch position locating section 311 transmits, to the process identifying section 112, information on the position of the contact by the object with the side-surface touch sensor 121. In a case where the touch position locating section 311 has consecutively received a plurality of results of detecting a contact by an object, the touch position locating section 311 transmits, to the process identifying section 112, corresponding pieces of information on the position of the contact by the object in the order in which the detection results were received. With this configuration, in a case where an object has been moved while being in contact with the side-surface touch sensor 121 (that is, a sliding operation has been carried out), the process identifying section 112 is capable of identifying the direction of the slide.

The process identifying section 112, on the basis of information on the position of a contact by an object with the side-surface touch sensor 121 which position has been located by the touch position locating section 311 of the touch sensor controller 111, identifies content of a process to be carried out which process is associated with the input operation by the user. The process identifying section 112 then transmits, to the process performing section 113, information on the process content identified. The process identifying section 112 ay, in a case where it has received information on the position of a contact by an object with the side-surface touch sensor 121 (that is, the user has carried out an input to the side-surface touch sensor 121), transmit the information received to the display control section 114 in order to cause the display 130 to display the information on the position of the contact.

The process identifying section 112 may, on the basis of (i) information on the position of a contact by an object with the side-surface touch sensor 121 and (ii) information on a predetermined image that the display control section 114 is causing the display 130 to display, identify content of a process to be carried out which process is associated with the input operation by the user. In this case, the process identifying section 112 identifies two different kinds of process content in a case where the information on the position of the contact indicates the same position but the display 130 is displaying two different images.

The process performing section 113, on the basis of information on process content which information has been received from the process identifying section 112, causes a corresponding block of the control section 110 (in particular, the display control section 114) to carry out a process corresponding to the process content. In a case where, for instance, the process identifying section 112 has identified a touch detected by the side-surface touch sensor 121 as a user operation for causing the display 130 to display a moving image captured by the rear-view camera 161 described later, the process performing section 113 obtains data on the moving image captured by the rear-view camera 161. The process performing section 113 then outputs the data on the moving image to the display control section 114.

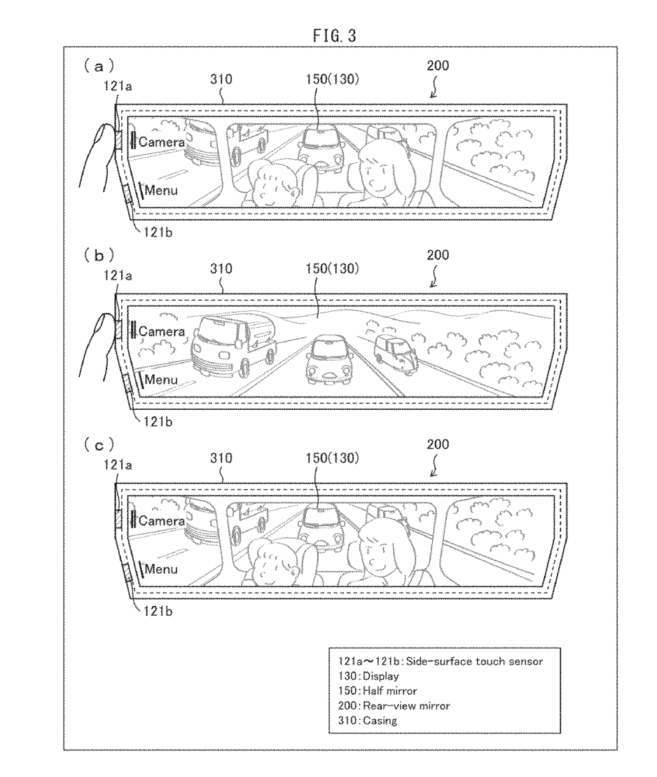

The display control section 1.14 carries out control for causing the display 130 to display a predetermined image. The display control section 114, for instance, causes the display 130 to display a moving image captured by the rear-view camera 161 and received from the process performing section 113. The display control section 114 may cause the display 130 to display an image (hereinafter referred to as “touchable position image”) that indicates for the user the position of a side surface of the casing 310 which position the user can touch for a process to be carried out. This allows the user to recognize a position to touch. The display 130, in other words, displays an image (that is, a touchable position image) indicative of a region on a side surface of the casing 310 in which region the rear-view mirror 200 accepts a touch. This image display will be described later in detail with reference to FIG. 3.

The display control section 114 may cause the display 130 to display an image indicative of the position of a touch on a side surface of the casing 310 which position has been detected by the side-surface touch sensor 121. Specifically, the display control section 114 may, upon receipt of information on a contact position from the process identifying section 112, cause the display 130 to display an image indicative of the touch position. The image displayed to indicate a touch position may be, for example, an image displayed for a predetermined time period which image is a variation (in terms of color, brightness, and/or the like) of the touchable position image described above. The image is, however, not limited to this example. The above configuration allows the user to recognize that the rear-view mirror 200 has accepted an input operation by the user.

The storage section 140 is a storage device for storing various data that the rear-view mirror 200 uses. The storage section 140 is configured to store the following data in a non-temporary manner: (1) control programs (not shown) that the control section 110 executes, (2) an OS program 141 that the control section 110 executes, (3) application programs (hereinafter referred to as “applications 142”) that the control section 110 executes to carry out various functions of the rear-view mirror 200, and (4) various data that the control section 110 reads to execute the applications 142. The storage section 140 also stores information such as (5) information (GUI 143 in FIG. 1) on a graphical user interface (GUI) that the display 130 displays. The above data (1) to (5) is stored in a nonvolatile storage device such as a read only memory (ROM), a flash memory, an erasable programmable ROM (EPROM), an electrically erasable programmable ROM (EEPROM [registered trademark]), or a hard disk drive (HDD). The rear-view mirror 200 may include a temporary storage section (not shown). The temporary storage section is a working memory configured to temporarily store (i) data that the rear-view mirror 200 uses for operations in carrying out various processes and (ii) the results of the operations. The temporary storage section includes a volatile storage device such as a random access memory (RAM). What data is to be stored in what storage device is determined as appropriate in view of the purpose of use of the rear-view mirror 200, convenience, cost, physical constraint, and/or the like. The storage section 140 is configured to further store various pieces of information that is generated by the above sections as the rear-view mirror 200 is operated. Such pieces of information generated include, for example, information on a touch position located by the touch position locating section 311 of the touch sensor controller 111.

(Detailed Configuration of In-Vehicle Device 160)

The present embodiment includes an in-vehicle device 160, which is mounted in the vehicle 300 and which is controlled by the rear-view mirror 200. The in-vehicle device 160 in accordance with the present embodiment is communicably connected to the rear-view mirror 200 with use of an in-vehicle line. The in-vehicle device 160 in accordance with the present embodiment includes a rear-view camera 161.

The rear-view camera 161 is an image capturing device mounted in the vehicle 300 to capture a view behind the vehicle 300. The rear-view camera 161 is controlled by the process performing section 113 of the rear-view mirror 200, and outputs data on a captured moving image to the process performing section 113 through the in-vehicle line.

The vehicle 300 may include, as the in-vehicle device 160, a camera configured to capture a view outside the vehicle 300 in a direction different from the direction in which the rear-view camera 161 captures a view.

With reference to FIG. 3, the following description will discuss operations (inputs) on the above-detailed rear-view mirror 200 and images displayed by the display 130 of the rear-view mirror 200.

(Operations on Rear-View Mirror 200 and Display Images)

FIG. 3 shows transition diagrams illustrating an example picture seen on the mirror surface of the rear-view mirror 200 which picture changes as the rear-view mirror 200 is operated. The term “picture” as used herein covers both a mirror image shown on the half mirror 150 and an image displayed by the display 130 (that is, a still image or moving image).

The mirror surface of the rear-view mirror 200 illustrated in (a) of FIG. 3 as an example shows a mirror image of a view behind the vehicle 300 and two touchable position images. The rear-view mirror 200 is configured to carry out a process only in a case where the region of a side-surface touch sensor 121a or side-surface touch sensor 121b has been touched. In other words, the touch position locating section 311 transmits, to the process identifying section 112, information on the position of a contact by an object with the side-surface touch sensor 121 only in a case where the touch position located is either a position on the side-surface touch sensor 121a or a position on the side-surface touch sensor 121b.

In (a) of FIG. 3, the user is touching the side-surface touch sensor 121a. The process identifying section 112, on the basis of information on a position on the side-surface touch sensor 121a which position has been located by the touch position locating section 311, identifies the input as an instruction to carry out a process of displaying a moving image captured by the rear-view camera 161, and transmits information on the process content to the process performing section 113. The process performing section 113, upon receipt of the information, obtains data on a moving image from the rear-view camera 161, and outputs the data to the display control section 114. The display control section 114, in response, causes the display 130 to display the moving image of a view behind the vehicle 300 as illustrated in (b) of FIG. 3.

In a case where the user has touched the side-surface touch sensor 121a while the moving image is being displayed as illustrated in (b) of FIG. 3, the process identifying section 112 identifies the input as an instruction to carry out a process of hiding the moving image captured by the rear-view camera 161, and transmits information on the process content to the process performing section 113. The process performing section 113, upon receipt of the information, stops obtaining data on a moving image from the rear-view camera 161. This causes the display 130 to stop displaying a moving image of a view behind the vehicle 300 and allows the user again to see a mirror image of the back seat of the vehicle 300 as illustrated in (c) of FIG. 3.

As described above, the rear-view mirror 200 in accordance with the present embodiment is configured such that a simple operation of touching a side surface of the casing 310 of the rear-view mirror 200 displays or hides a moving image of a view behind the vehicle 300. In a case where a moving image captured by the rear-view camera 161 of a view behind the vehicle 300 is displayed by the display 130 as illustrated in (b) of FIG. 3, the situation behind the vehicle 300 can be displayed without being obstructed by a person or thing present in the vehicle 300. In a case where the rear-view camera 161 is capable of capturing an image in an image capturing mode suitable for nighttime, rainy weather, or the like, the display 130 can display a clear moving image if a mirror image does not allow the user to easily check a view behind the vehicle 300 due to nighttime, rainy weather, or the like. This allows the user to drive safely. Note that FIG. 3 is not intended to illustrate limiting examples of (i) operations on the rear-view mirror 200, (ii) processes that the rear-view mirror 200 carries out, and (iii) images that the display 130 of the rear-view mirror 200 displays.

With reference to FIG. 4, the following description will discuss an example of how the side-surface touch sensor 121 is actually formed on the side surface of the casing 310.

(Example of Actual Side-Surface Touch Sensor 121)

FIG. 4 shows diagrams illustrating an example of sensor electrodes 212 disposed on the casing 310 of the rear-view mirror 200 to form a side-surface touch sensor 121. As illustrated in FIG. 4, the casing 310 includes (i) a casing bottom surface 310F, that is a bottom surface portion of the casing 310, and (ii) a casing side surface 310S, that is, a side surface portion of the casing 310. The plurality of sensor electrodes 212 are disposed next to each other on the inner side of the casing side surface 310S (that is, on the side on which the display 130 and the half mirror 150 are present), and detect a touch on the casing side surface 310S. Specifically, FIG. 4 illustrates an example involving a sensor electrode 212a and a sensor electrode 212b that are disposed next to each other at a predetermined interval W and that are positioned between a plurality of ribs 310R (hereinafter referred to as “casing ribs 310R”) on the inner side of the casing side surface 310S. The plurality of casing ribs 310R form a clearance between (i) the sensor electrodes 212 and the display 130 and the half mirror 150 incorporated in the casing 310. Specifically, as illustrated in FIG. 4 as an example, the plurality of casing ribs 310R are present on the inner side of the casing side surface 310S and each protrude from the inner surface of the casing side surface 310S toward the respective peripheral edges of the display 130 and the half mirror 150 by a predetermined thickness C. The plurality of sensor electrodes 212 (for example, the sensor electrode 212a and sensor electrode 212b) are each positioned between two of the plurality of casing ribs 310R. The predetermined thickness C of each casing rib 310R is, for example, 0.5 mm. The sensor electrodes 212 each have a thickness of, for example, 0.1 mm. In this example, there is a clearance of approximately 0.4 mm between the respective surfaces of the sensor electrodes 212 and (ii) the respective peripheral edges of the display 130 and the half mirror 150. The plurality of sensor electrodes 212 each have a reliable sensitivity, with (i) the casing side surface 310S having, on the inner side, a plurality of casing ribs 310R each protruding toward the respective peripheral edges of the display 130 and the half mirror 150 by a predetermined thickness T and the sensor electrodes 212 positioned between the casing ribs 310R.

Each casing rib 310R has a width of, for example, 1 mm; in other words, the predetermined interval W between the sensor electrode 212a and the sensor electrode 212b is, for example, 1 mm. Arranging the plurality of sensor electrodes 212 next to each other at the predetermined interval W makes it possible to locate the position of a touch on the casing side surface 310S.

### Embodiment 2

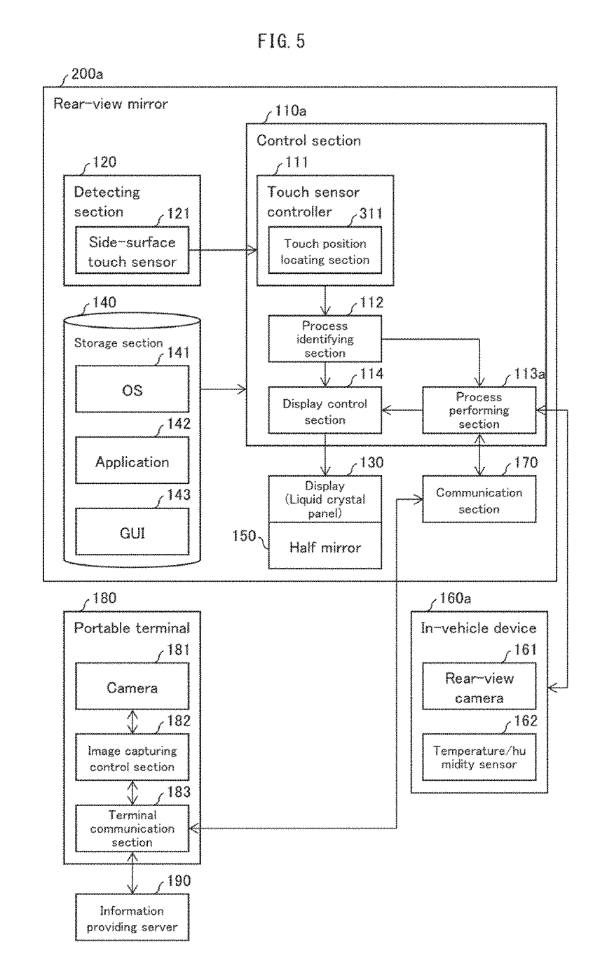

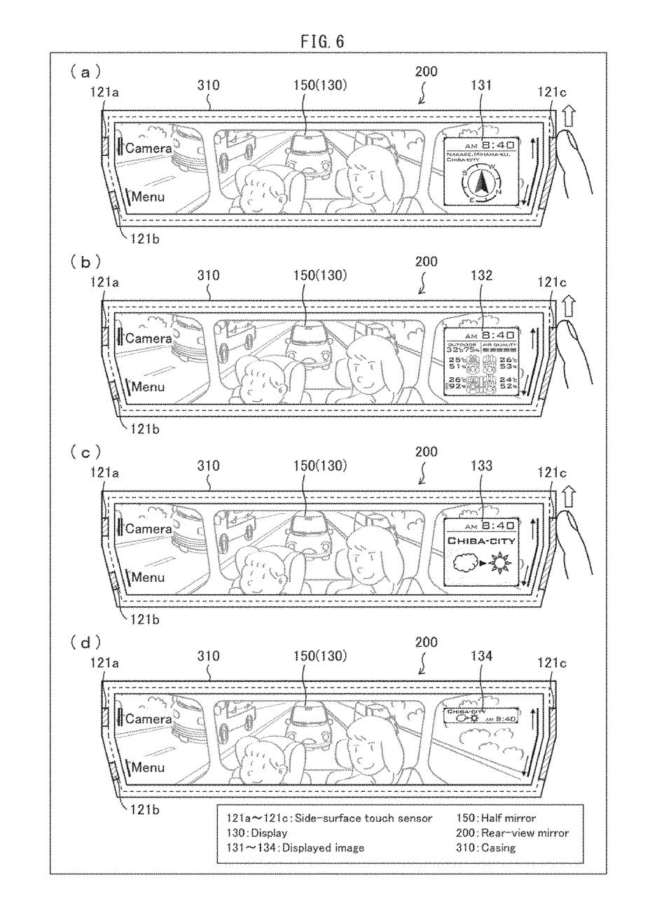

The following description will discuss another embodiment of the present invention with reference to FIGS. 5 and 6. The description below first outlines a rear-view mirror 200a in accordance with the present embodiment. The rear-view mirror 200a in accordance with the present embodiment is configured to (i) obtain information on the temperature and humidity detected by a temperature/humidity sensor 162 and (ii) cause the display 130 to display an image indicative of that information. The rear-view mirror 200a in accordance with the present embodiment is further configured to (i) obtain various pieces of information from an information providing server 190 via a portable terminal 180 and (ii) cause the display 130 to display an image indicative of that information.

(Detailed Configuration of Rear-View Mirror 200a and In-Vehicle Device 160a)

FIG. 5 is a block diagram illustrating an example configuration of main sections of the rear-view mirror 200a. As illustrated in FIG. 5, the rear-view mirror 200a in accordance with the present embodiment differs from the rear-view mirror 200 described for Embodiment 1 in that the control section 110 is replaced with a control section 110a. The rear-view mirror 200a in accordance with the present embodiment additionally includes a communication section 170. The in-vehicle device 160a in accordance with the present embodiment additionally includes a temperature/humidity sensor 162.

The communication section 170 is a communication device configured to transmit information to and receive information from a portable terminal 180 by radio communication. The means of the communication by the communication section 170 is not limited to any particular one, but is preferably Wi-Fi, as it can simplify the function of the communication section 170.

The control section 110a is configured such that the process performing section 113 described for Embodiment 1 is replaced with a process performing section 113a. The process performing section 113a has the same function as the process performing section 113 described for Embodiment 1, and additionally, when the rear-view mirror 200a is turned on, starts obtaining information on the temperature and humidity detected by the temperature/humidity sensor 162. The process performing section 113a repeatedly obtains information on the temperature and humidity at predetermined timing until the rear-view mirror 200a is turned off.

The process performing section 113a, when the rear-view mirror 200a is turned on, further obtains, from the information providing server 190 via the communication section 170 and the portable terminal 180, information on (i) the current position and traveling direction of the vehicle 300 and (ii) the weather at the current location of the vehicle 300. The process performing section 113a repeatedly obtains information on the current position and traveling direction of the vehicle 300 at predetermined timing until the rear-view mirror 200a is turned off. The process performing section 113a obtains weather information each time the vehicle 300 enters a municipality from another. The process performing section 113a obtains weather information for each municipality as such as a mere example; the function of obtaining weather information is not limited to this example. The present embodiment is an example of obtaining information indicative of the current position and traveling direction of the vehicle 300 from the information providing server 190 via the portable terminal 180. The process performing section 113a may alternatively obtain the information from a car navigation system mounted in the vehicle 300.

The process performing section 113a outputs, to the display control section 114, information obtained on the temperature, humidity, current position and traveling direction of the vehicle 300, and weather. Information that the process performing section 113a obtains is not limited to this example.

The temperature/humidity sensor 162 is disposed at such a position as to be capable of measuring the temperature and humidity of each seat of the vehicle 300 and the temperature and humidity of the outside of the vehicle 300. The temperature/humidity sensor 162 detects measures) the temperature and humidity of the vicinity of each seat of the vehicle 300 and the temperature and humidity of the outside of the vehicle 300, and outputs information on the temperature and humidity detected to the process performing section 113a of the rear-view mirror 200. The vehicle 300 may include, as the in-vehicle device 160a, a sensor (hereinafter referred to as “in-vehicle sensor”) other than the temperature/humidity sensor 162. The in-vehicle sensor may be any sensor that senses the environment or situation inside the vehicle 300.

The temperature/humidity sensor 162 of the present embodiment is connected to the rear-view mirror 200a with use of an in-vehicle line and communicates with the rear-view mirror 200a by cable communication. Alternatively, an in-vehicle sensor such as the temperature/humidity sensor 162 or a data collection device configured to collect data from an in-vehicle sensor such as the temperature/humidity sensor 162 may communicate with the rear-view mirror 200a by radio communication via the communication section 170. The mode of this communication is, for example, Bluetooth (registered trademark), but is not limited to this example

(Detailed Configuration of Portable Terminal 180)

The portable terminal 180 is a terminal device capable of radio communication with an external device. Examples include a mobile telephone and a smartphone. The portable terminal 180 includes a camera 181, an image capturing control section 182, and a terminal communication section 183. The camera 181 and the image capturing control section 182 will be described later in detail for Embodiment 3.

The terminal communication section 183 obtains various pieces of information (for example, information on the current position and traveling direction of the vehicle 300 and the weather at the current location of the vehicle 300) from the information providing server 190 in accordance with an instruction from the process performing section 113a of the rear-view mirror 200a, and transmits the information to the rear-view mirror 200a.

(Information Providing Server 190)

The information providing server 190 provides various pieces of information to the rear-view mirror 200a. Specifically, the information providing server 190 provides and manages a car navigation service, and outputs, to the rear-view mirror 200a via the portable terminal 180, information on the current position and traveling direction of the vehicle 300. The information providing server 190 also provides and manages a weather forecast service, and outputs, to the rear-view mirror 200a via the portable terminal 180, information on the weather in the area (municipality) in which the vehicle 300 is present. The above configuration may alternatively be varied such that one information providing server provides and manages a car navigation service and another information providing server provides and manages a weather forecast service. The services that the information providing server 190 provides and manages and the information that the information providing server 190 outputs to the rear-view mirror 200a are not limited to the above examples.

With reference to FIG. 6, the following description will discuss operations (inputs) on the rear-view mirror 200a in accordance with the present embodiment and images displayed by the display 130 of the rear-view mirror 200a.

(Operations on Rear-View Mirror 200a and Display Images)

FIG. 6 shows transition diagrams illustrating an example picture seen on the mirror surface of the rear-view mirror 200a which picture changes as the rear-view mirror 200a is operated.

The mirror surface of the rear-view mirror 200a illustrated in (a) of FIG. 6 as an example shows a mirror image of a view behind the vehicle 300 and three touchable position images on the display 130. The rear-view mirror 200a is configured to carry out a process only in a case where the region of a side-surface touch sensor 121a, 121b, or 121c has been touched. In other words, the touch position locating section 311 transmits, to the process identifying section 112, information on the position of a contact by an object with the side-surface touch sensor 121 only in a case where the touch position located is a position on the side-surface touch sensor 121a, 121b, or 121c.

The rear-view mirror 200a displays an image 131 indicative of the current position and traveling direction of the vehicle 300 in a far-right region of the display 130 in FIG. 6 (hereinafter referred to simply as “far-right region”). The image 131 is created by the display control section 114 on the basis of information on the current position and traveling direction of the vehicle 300 which information has been obtained by the process performing section 113a. The display control section 114 updates the image 131 each time there is a change to the current position (in the example illustrated in FIG. 6, the name of the area in which the vehicle 300 is present) and/or traveling direction of the vehicle 300 both included in the information that the display control section 114 receives from the process performing section 113a. Displaying the image 131 in a far-right region of the display 130 as above allows a sufficient region for a mirror image of a view behind the vehicle 300. The above configuration thus allows an image to be displayed without preventing the user from checking a view behind. The region of the display 130 in which region to display the image 131 is not limited to the far-right region as long as the region leaves a sufficient region for a mirror image of a view behind the vehicle 300. The region may alternatively be, for example, a far-left region of the display 130 in FIG. 6.

(a) of FIG. 6 illustrates the user touching a side-surface touch sensor 121c with a finger and sliding the finger upward in FIG. 6. The process identifying section 112, on the basis of a plurality of pieces of information on positions on the side-surface touch sensor 121c which positions have been located by the touch position locating section 311, identifies the direction of the slide of the finger and thereby identifies the input as an instruction to carry out a process of scrolling the image 131 upward. The process identifying section 112 then transmits information on the process content to the display control section 114. The display control section 114, upon receipt of the information, replaces the image 131 with an image 132 to be displayed on the display 130 as illustrated in (b) of FIG. 6.

The image 132 shows the temperature and humidity of the vicinity of each seat of the vehicle 300 and the temperature and humidity of the outside of the vehicle 300. The image 132 is created by the display control section 114 on the basis of information on the temperature and humidity of the vicinity of each seat of the vehicle 300 and the temperature and humidity of the outside of the vehicle 300 which information has been obtained by the process performing section 113a. from the temperature/humidity sensor 162. The display control section 114 updates the image 132 each time there is a change to the temperature and humidity both included in the information that the display control section 114 receives from the process performing section 113a. Displaying the temperature and humidity of the vicinity of each seat of the vehicle 300 on the display 130 of the rear-view mirror 200a as above allows the driver to easily check the situation of each seat, in particular the situation of the back seat, which is difficult for the driver to check. For instance, the image 132 illustrated in (b) of FIG. 3 as an example shows a high humidity for the vicinity of the seat on which a child seat is set. Displaying such information on the display 130 allows the driver and another person(s) in the vehicle to easily recognize the possibility of an abnormality about the child (for example, a possible need to change the diaper)

(b) of FIG. 6 illustrates the user touching the side-surface touch sensor 121c with a finger and sliding the finger upward in FIG. 6. The process identifying section 112, similarly to the above, identifies the input as an instruction to carry out a process of scrolling the image 132 upward, and transmits information on the process content to the display control section 114. The display control section 114, in response, replaces the image 132 with an image 133 to be displayed on the display 130 as illustrated in (c) of FIG. 6.

The image 133 shows the weather in the municipality in which the vehicle 300 is present. The image 133 is created by the display control section 114 on the basis of information on the weather at the current location of the vehicle 300 which information has been obtained by the process performing section 113a. The display control section 114 updates the image 133 each time it obtains weather information from the process performing section 113a.

(c) of FIG. 6 illustrates the user touching the side-surface touch sensor 121c with a finger and sliding the finger upward in FIG. 6. The process identifying section 112, similarly to the above, identifies the input as an instruction to carry out a process of scrolling the image 133 upward, and transmits information on the process content to the display control section 114. The display control section 114, in response, replaces the image 133 with an image 134 to be displayed on the display 130 as illustrated in (d) of FIG. 6.

The image 134, similarly to the image 133, shows the weather in the municipality in which the vehicle 300 is present, but is smaller in size than the image 133. Displaying such an image on the display 130 allows the user to receive various pieces of information and also improves the visibility of the rear-view mirror 200a.

Note that FIG. 6 is not intended to illustrate limiting examples of (1) operations on the rear-view mirror 200a, (ii) processes that the rear-view mirror 200a carries out, and (iii) images that the display 130 of the rear-view mirror 200a displays. The rear-view mirror 200a may alternatively be configured such that touching a side-surface touch sensor 121 displays or hides an image such as the image 131.

The process performing section 113a of the rear-view mirror 200a may obtain, from the portable terminal 180, the car navigation system, and/or the like, information on the route that the vehicle 300 will take. The process performing section 113a can, with use of that information, obtain information in advance on the weather at a location on the route or at the destination. This allows the display control section 114 to cause the display 130 to display an image indicative of the weather at a location on the route that the vehicle 300 will take and/or the weather at the destination. The information that the process performing section 113a obtains with use of information on the route that the vehicle 300 will take is not limited to weather information.

The present embodiment is configured such that when the rear-view mirror 200a is turned on, the process performing section 113a obtains various pieces of information for creating, for example, the image 131. The configuration may alternatively be varied such that the process performing section 113a obtains such pieces of information in a case where there has been a touching operation on the side-surface touch sensor 121c (in other words, in a case where the process identifying section 112 has identified an input as an instruction to carry out a process of scrolling an image upward or downward).

For instance, as illustrated in (a) of FIG. 6, in a case where the process identifying section 112 has, while the image 131 is being displayed on the display 130, identified an upward slide in FIG. 6 and thereby identified the input as an instruction to carry out a process of scrolling the image 131 upward, the process identifying section 112 transmits information on the process content to the process performing section 113a. The process performing section 113a, upon receipt of the information, controls the temperature/humidity sensor 162 in order to obtain information on the temperature and humidity, and outputs the information on the temperature and humidity to the display control section 114. The display control section 114, in response, creates an image 132 with use of the information received, and causes the display 130 to display the image 132.

Further, for instance, as illustrated in (b) of FIG. 6, in a case where the process identifying section 112 has, while the image 132 is being displayed on the display 130, identified an upward slide in FIG. 6 and thereby identified the input as an instruction to carry out a process of scrolling the image 132 upward, the process identifying section 112 transmits information on the process content to the process performing section 113a. The process performing section 113a, upon receipt of the information, instructs the portable terminal 180 via the communication section 170 to (i) obtain, from the information providing server 190, information on the current position of the vehicle 300 and the weather at the current location of the vehicle 300 and (ii) transmit the information to the rear-view mirror 200a. The process performing section 113a. outputs the weather information received to the display control section 114. The display control section 114 creates an image 133 with use of the information received, and causes the display 130 to display the image 133.

The present embodiment is configured such that the rear-view mirror 200a obtains information on the current position and traveling direction of the vehicle 300 and the weather at the current location of the vehicle 300 from the information providing server 190 via the portable terminal 180. The rear-view mirror 200a may alternatively obtain the above information directly from the information providing server 190. In this case, the mode of the communication by the communication section 170 may even be 3G (third-generation cellular phone communication standard) or LTE (long term evolution). The rear-view mirror 200a may alternatively obtain the above information from the information providing server 190 via, instead of the portable terminal 180, a communication module disposed in the vehicle 300. The communication section 170 and the communication module preferably communicate with each other through Wi-Fi. The communication module and the information providing server 190 preferably communicate with each other on the basis of 3G, LTE, or the like.

### Embodiment 3

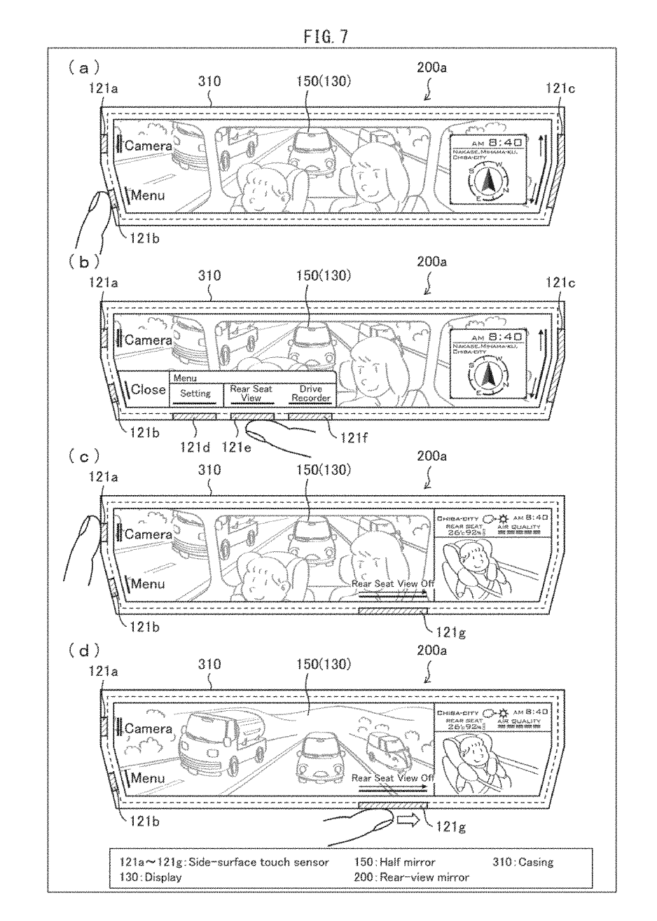

The following description will discuss still another embodiment of the present invention with reference to FIGS. 5 and 7. The description below first outlines a rear-view mirror 200a in accordance with the present embodiment. The rear-view mirror 200a in accordance with the present embodiment is configured to (i) obtain a moving image of a child sitting in the back seat (child seat) which moving image has been captured by a portable terminal 180 and (ii) cause the display 130 to display the moving image. The present embodiment is, in other words, configured such that the portable terminal 180 is disposed at such a position in the vehicle 300 as to be capable of capturing an image of a child sitting in the back seat.

With reference to FIG. 5, the following description will discuss a camera 181 and an image capturing control section 182 both included in the portable terminal 180.

(Detailed Configuration of Portable Terminal 180)

The camera 181 is an image capturing device capable of capturing at least a moving image. The camera 181 is controlled by the image capturing control section 182. The camera 181 captures a moving image and outputs data on the moving image to the image capturing control section 182.

The image capturing control section 182 controls the camera 181. Specifically, the image capturing control section 182, upon receipt of an image capturing instruction from the process performing section 113a of the rear-view mirror 200a via the terminal communication section 183, activates the camera 181 to start capturing a moving image. The image capturing control section 182 then transmits, to the rear-view mirror 200a via the terminal communication section 183, data on the moving image captured by the camera 181 (in other words, data on the moving image obtained from the camera 181).

With reference to FIG. 7, the following description will discuss operations (inputs) on the rear-view mirror 200a in accordance with the present embodiment and images displayed by the display 130 of the rear-view mirror 200a.

(Operations on Rear-View Mirror 200a and Display Images)

FIG. 7 shows transition diagrams illustrating an example picture seen on the mirror surface of the rear-view mirror 200a which picture changes as the rear-view mirror 200a is operated.

The mirror surface of the rear-view mirror 200a illustrated in (a) of FIG. 7 as an example shows, similarly to (a) of FIG. 6 referred to for description of Embodiment 2, a mirror image of a view behind the vehicle 300 and three touchable position images on the display 130. In (a) of FIG. 7, the user is touching the side-surface touch sensor 121b. The process identifying section 112, on the basis of information on a position on the side-surface touch sensor 121b which position has been located by the touch position locating section 311, identifies the input as an instruction to carry out a process of displaying a menu image, and transmits information on the process content to the display control section 114. The display control section 114, upon receipt of the information, causes the display 130 to display a menu image as illustrated in (b) of FIG. 7 which menu image allows the user to select a process to be carried out.

The rear-view mirror 200a, in a case where it causes the display 130 to display a menu image, designates each of the respective regions of side-surface touch sensors 121d, 121e, and 121f illustrated in (b) of FIG. 7 as a region that the user can touch for a process to be carried out. In other words, after the rear-view mirror 200a has caused the display 130 to display a menu image, the touch position locating section 311 transmits, to the process identifying section 112, information on the position of a contact by an object with the side-surface touch sensor 121 only in a case where the touch position located is a position on the side-surface touch sensor 121a, 121b, 121c, 121d, 121e, or 121f.

In a case where the user has touched the side-surface touch sensor 121e as illustrated in (b) of FIG. 7, the process identifying section 112 identifies the input as an instruction to carry out a process of displaying the moving image captured by the portable terminal 180, and transmits information on the process content to the process performing section 113a. The process performing section 113a, upon receipt of the information, obtains data on a moving image from the portable terminal 180 via the communication section 170, and outputs the data to the display control section 114. The display control section 114, in response, causes the display 130 to display, in a far-right region thereof, the moving image of the child in the back seat as illustrated in (c) of FIG. 7. This allows the user sitting in the driver's seat or passenger's seat to see the child in the back seat by simply looking in the rear-view mirror 200a.

As illustrated in (c) of FIG. 7, the rear-view mirror 200a, in a case where it causes the display 130 to display a moving image obtained from the portable terminal 180, designates each of the respective regions of the side-surface touch sensors 121d, 121e, and 121f, which regions have each been designated as a region that the user can touch for a process to be carried out, as not a region that the user can touch for a process to be carried out. In other words, after the rear-view mirror 200a has caused the display 130 to display a moving image obtained from the portable terminal 180, the touch position locating section 311 does not transmit, to the process identifying section 112, information on the position of a contact by an object with the side-surface touch sensor 121 in a case where the touch position located is a position on the side-surface touch sensor 121d, 121e, or 121f. The rear-view mirror 200a newly designates the region of a side-surface touch sensor 121g as a region that the user can touch for a process to be carried out. In other words, after the rear-view mirror 200a has caused the display 130 to display a moving image obtained from the portable terminal 180, the touch position locating section 311 transmits, to the process identifying section 112, information on the position of a contact by an object with the side-surface touch sensor 121 only in a case where the touch position located is a position on the side-surface touch sensor 121a, 121b, 121c, or 121g.

In a case where the user has touched the side-surface touch sensor 121a as illustrated in (c) of FIG. 7, a moving image captured by the rear-view camera 161 is displayed as illustrated in (d) of FIG. 7 in that portion of the display 130 which corresponds to the portion in which a mirror image was being displayed (that is, the portion other than the portion in which a moving image of the child in the back seat was being displayed). In a case where as illustrated in (d) of FIG. 7, the user has touched the side-surface touch sensor 121g with a finger and has slid the finger to the right in FIG. 7, the process identifying section 112 identifies the input as an instruction to carry out a process of hiding the moving image captured by the portable terminal 180, and transmits information on the process content to the process performing section 113a. The process performing section 113a, upon receipt of the information, stops obtaining data on a moving image from the portable terminal 180. This causes the display 130 to no longer display a moving image of the child in the back seat (not illustrated in FIG. 7).

Note that FIG. 7 is not intended to illustrate limiting examples of (i) operations on the rear-view mirror 200a, (ii) processes that the rear-view mirror 200a carries out, and (iii) images that the display 130 of the rear-view mirror 200a displays. The rear-view mirror 200a may, for instance, be configured such that (i) the user touching the side-surface touch sensor 121d illustrated in (b) of FIG. 7 causes a transition to a screen for various settings for screen adjustment and/or the like or that (ii) the user touching the side-surface touch sensor 121f illustrated in (b) of FIG. 7 causes a transition to a screen for selecting and replaying a moving image recorded by an in-vehicle recorder.

The present embodiment uses the portable terminal 180 to capture an image of the child sitting in the back seat. The configuration may alternatively be varied to use an image capturing device (for example, a camera) mounted in the vehicle 300. In that example, the image capturing device and the rear-view mirror 200a may be communicably connected to each other with use of an in-vehicle line. Further, a video image captured by the image capturing device may be transmitted to the rear-view mirror 200a via the communication module described for Embodiment 2. In this case, (i) the image capturing device and the communication module may be connected to each other in such a manner that allows cable or radio communication, or (ii) the image capturing device may even be integrated with the communication module.

[Variations]

The device (in-vehicle device) that the process performing section 113 or process performing section 113a controls is not limited to the examples described for the above embodiments. Examples of the device include an air conditioner, audio equipment, and car navigation system of the vehicle 300.

A rear-view mirror in accordance with an embodiment of the present invention may be a device that has only the function of accepting an input operation by the user and the function of displaying an image. A rear-view mirror in accordance with an embodiment of the present invention may, for example, be configured to (i) transmit, to an in-vehicle device (control device) other than the rear-view mirror, the result of the side-surface touch sensor 121 detecting a contact by an object with the side-surface touch sensor 121 and (ii) cause the display 130 to display an image received from the control device.

As described above, a rear-view mirror in accordance with an embodiment of the present invention is configured such that an operation of touching the side-surface touch sensor 121 allows, for example, an image associated with the operation to be displayed on the display 130 or a process associated with the operation to be carried out. A rear-view mirror in accordance with an embodiment of the present invention is, in other words, usable as an operation device for carrying out various functions by switching images to be displayed in association with an operation or processes to be carried out in association with an operation.

### Embodiment 4

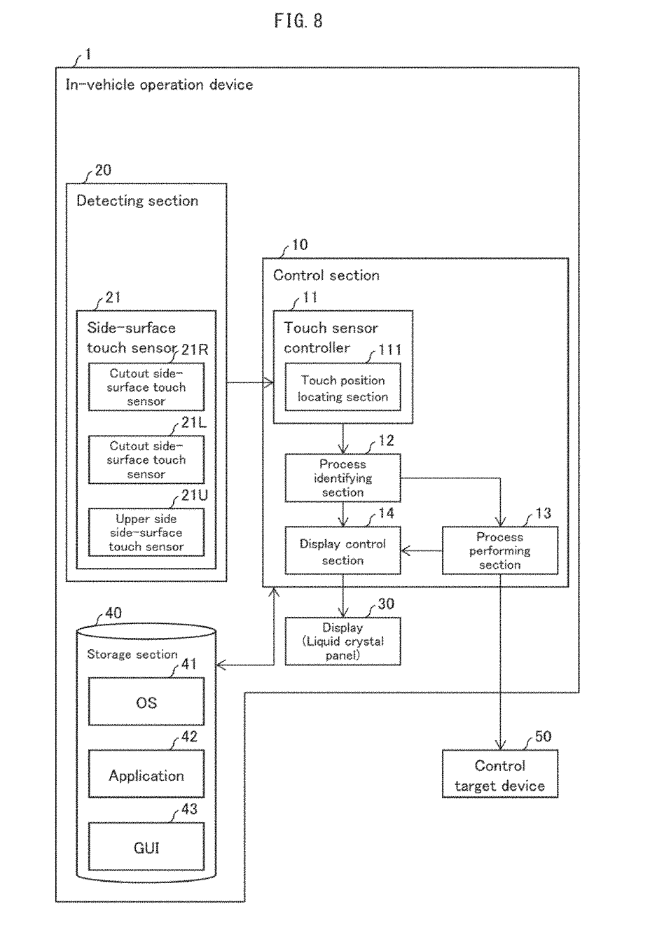

The following description will discuss still another embodiment of the present invention with reference to FIGS. 8 to 18. In the description below, any member of a particular embodiment that is identical in function to a member of another embodiment described earlier is assigned a common reference sign, and may not be described for that particular embodiment for convenience of explanation.

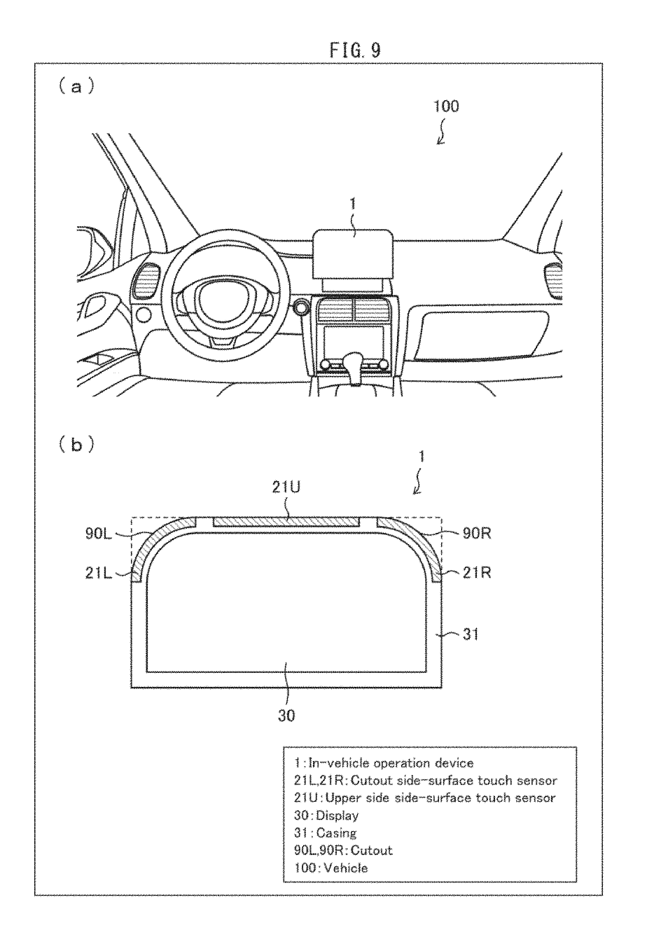

To facilitate understanding of an in-vehicle operation device 1 (in-vehicle operation device) in accordance with the present embodiment, the description below first deals with an outline of the in-vehicle operation device 1 with reference to FIG. 9.

(Outline of In-Vehicle Operation Device 1)

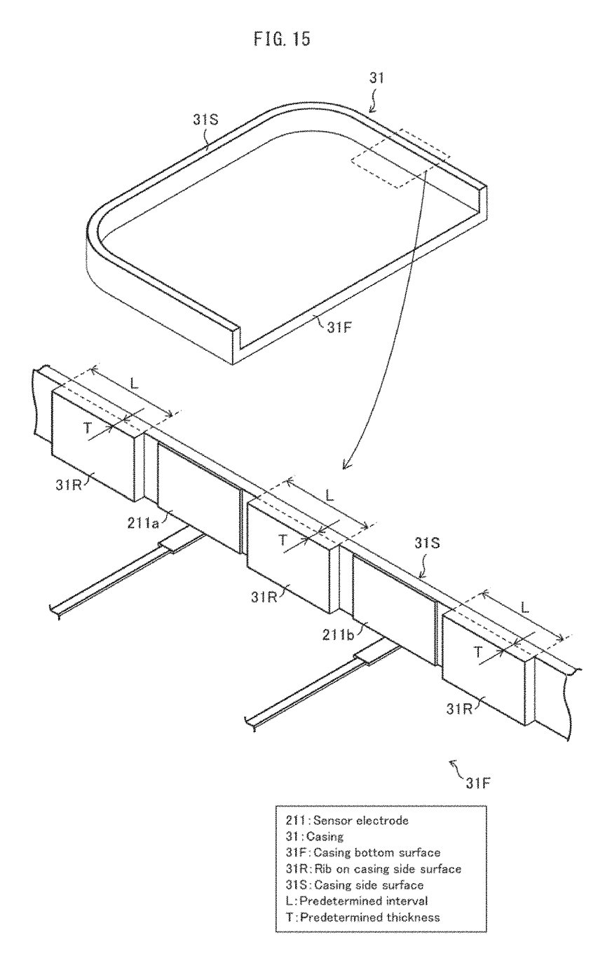

FIG. 9 shows diagrams illustrating an outline of the in-vehicle operation device 1. (a) of FIG. 9 is a diagram schematically illustrating how the in-vehicle operation device 1 is mounted in a vehicle 100. (b) of FIG. 9 is a diagram schematically illustrating the appearance of the in-vehicle operation device 1. The in-vehicle operation device 1 is mounted in the vehicle 100 as illustrated in (a) of FIG. 9. The in-vehicle operation device 1 accepts an operation by a user such as the driver to control the respective operations of control target devices 50 such as an air conditioner, audio equipment, car navigation system, and in-vehicle camera of the vehicle 100. The user can touch a side-surface touch sensor 21 incorporated inn a side surface (corresponding to the casing side surface 31S in FIG. 15) of a casing 31 for various settings of the control target devices 50 and the in-vehicle operation device 1. The user can, for instance, touch the side surface of the casing 31 with a finger and slide the finger to change the set temperature of the air conditioner as a control target device 50.

As illustrated in (b) of FIG. 9, the in-vehicle operation device 1 includes a display 30 that has, on its periphery, gently curved (rounded) portions (namely, cutouts 90R and 90L). Specifically, the display 30 of the example illustrated in (b) of FIG. 9 has a cutout 90R at the upper right of the display 30 and a cutout 90L at the upper left of the display 30 both as viewed by a user standing in front of the display 30.

The casing 31, which houses the display 30, has a side surface (corresponding to the casing side surface 31S in FIG. 15) that has gently curved portions (that is, portions corresponding respectively to the cutouts 90R and 90L) along the periphery of the display 30. The portions of the side surface of the casing 31 that correspond respectively to the cutouts 90R and 90L of the display 30 are provided respectively with cutout side-surface touch sensors 21R and 21L. More specifically, the in-vehicle operation device 1 includes (i) a cutout side-surface touch sensor 21R on an upper right portion of the side surface of the casing 31 (which houses the display 30), (ii) a cutout side-surface touch sensor 21L on an upper left portion of the side surface, and (iii) an upper side side-surface touch sensor 21U on an upper portion of the side surface, all as viewed by a user standing in front of the display 30. It is, however, not essential for the side surface of the casing 31 (which houses the display 30) to be provided with three side-surface touch sensors 21, namely the cutout side-surface touch sensor 21L, cutout side-surface touch sensor 21R, and upper side side-surface touch sensor 21U. The side surface of the casing 31 (which houses the display 30) may, for instance, be provided with a single side-surface touch sensor 21 extending along the entire side surface. The in-vehicle operation device 1 may be configured to carry out a predetermined process associated with a touch position detected by the single side-surface touch sensor 21, which extends along the entire side surface of the casing 31.

The description below simply uses the term “side-surface touch sensor 21” if there is no particular need to distinguish between the cutout side-surface touch sensor 21R, cutout side-surface touch sensor 21L, and upper side side-surface touch sensor 21U. Similarly, the description below simply uses the term “cutout 90” if there is no particular need to distinguish between the cutout 90R and cutout 90L.

The in-vehicle operation device 1 accepts an input by the user to the side surface (or an edge thereof) of the casing 31 through a side-surface touch sensor 21. The side-surface touch sensor 21 is disposed on a portion of the side surface of the casing 31 (in which the display 30 is incorporated) which portion has an orientation that gently varies along the periphery of the display 30. With this configuration, the feel (sensation) that the user experiences when touching the side surface of the casing 31 varies according to the touch position. In other words, the direction (that is, the angle) of a portion of the side surface of the casing 31 which portion the user touches varies according to the touch position. This allows the user to recognize, without looking at the in-vehicle operation device 1 (specifically, the display 30) or by simply looking at the in-vehicle operation device 1 for an extremely short moment (for example, 1 second to 1.5 seconds), which position on the side surface of the casing 31 the user has touched. Further, even in a case where the user has touched the side surface of the casing 31 with a finger and slid the finger without looking at the in-vehicle operation device 1, the user can recognize an approximate distance over which the user has moved the finger.

With the above configuration, the user (driver) can touch the side surface of the casing 31 (that is, the edge of the display 30) to operate the in-vehicle operation device 1 safely and intuitively. More specifically, the driver can touch a curved portion of the side surface of the casing 31 (that is, the periphery of the display 30) on the basis of the feel to easily operate the in-vehicle operation device 1. The driver can, in other words, operate the in-vehicle operation device 1 without looking at the in-vehicle operation device 1. This ensures great safety. Further, the driver can operate the in-vehicle operation device 1 intuitively as if to rotate a dial (knob) along a curved portion of the side surface of the casing 31 (that is, the periphery of the display 30).

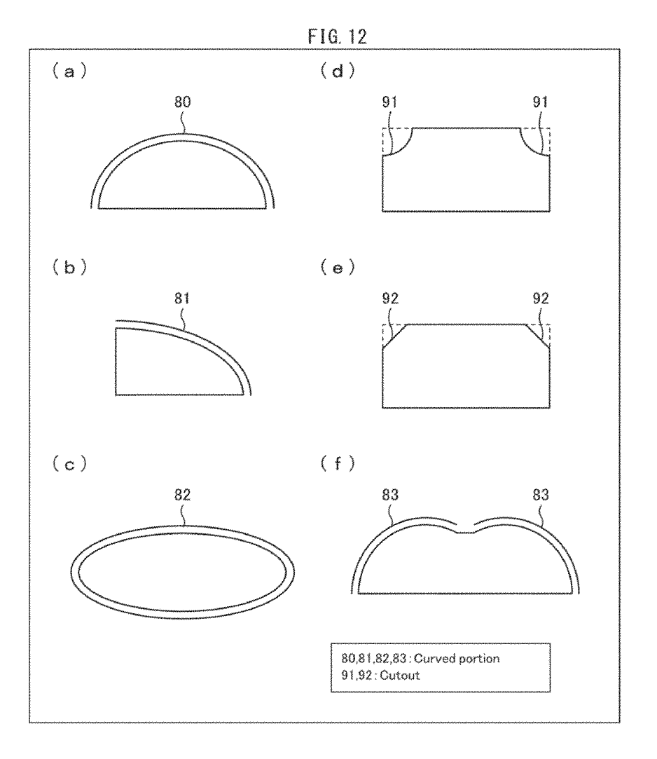

The in-vehicle operation device 1, which produces the above effects, is first outlined as follows: The in-vehicle operation device 1 includes a display 30, a casing 31, and a side-surface touch sensor 21. The display 30 (display screen) has, on its periphery, curved portions 80, 81, 82, and 83 illustrated in FIG. 12 as examples or cutouts 90, 91, and 92 illustrated in FIGS. 9 and 12 as examples. The casing 31 houses the display 30 assembled thereto, and has a side surface (corresponding to the casing side surface 31S in FIG. 15) along the periphery of the display 30 which side surface extends in the direction of the depth of the display 30. The side-surface touch sensor 21 (side-surface touch detecting section) detects a touch by the user on at least a position on a portion of the side surface of the casing 31 which portion extends along a curved portion or cutout mentioned above of the display 30.

With the above configuration, the casing 31 has a periphery that extends along the periphery of the display 30 as illustrated in FIG. 9 as an example. Thus, the user, when having touched the side surface of the casing 31, experiences the feel that varies according to the touch position. This allows the user (for example, the driver) to guess the touch position by means of the feel, in other words, to recognize the touch position without looking at the touch position. The above configuration thus allows even the driver to easily and safely cause the in-vehicle operation device 1 to carry out a predetermined process associated with a touch position.

The vehicle 100 is equipped with the in-vehicle operation device 1 mounted therein. The vehicle 100, which is configured as such, allows the user (for example, the driver) to guess the touch position by means of the feel and cause the in-vehicle operation device 1 to carry out a predetermined process associated with the touch position. This allows even the driver of the vehicle 100 to easily and safely operate the in-vehicle operation device 1 as desired.

The description above has outlined how the in-vehicle operation device 1 is mounted in the vehicle 100 and the appearance of the in-vehicle operation device 1 with reference to FIG. 9. The description below deals with the in-vehicle operation device 1 in greater detail with reference to FIG. 8.

(Detailed Configuration of In-Vehicle Operation Device 1)

FIG. 8 is a block diagram illustrating an example configuration of main sections of the in-vehicle operation device 1. As illustrated in FIG. 8, the in-vehicle operation device 1 includes a control section 10, a detecting section 20, a display 30, and a storage section 40. The in-vehicle operation device 1 may be configured to include a casing 31 housing the display 30 which casing 31 includes, for example, (i) a power source button (power switch) for turning the in-vehicle operation device 1 on and off and/or (ii) a control for adjusting the volume of in-vehicle audio equipment configured to be operated via the in-vehicle operation device 1. Such a power source button, a control, or the like is not shown in FIG. 8, as it is not directly related to any feature of the present invention.

The display 30 includes, for example, a liquid crystal panel as a predetermined display screen, and displays an image or the like. The display panel included in the display 30 is not limited to a liquid crystal panel, and may be an organic electroluminescent (EL) panel, an inorganic EL panel, a plasma panel, or the like.

The display 30 has cutouts 90 as illustrated in (b) of FIG. 9 as an example. Those portions of the side surface of the casing 31 (which houses the display 30) which extend along the respective cutouts 90 of the display 30 are provided with respective side-surface touch sensors 21. The display 30 may have, on its periphery, at least one of the curved portions 80, 81, 82, and 83 illustrated in FIG. 12 as examples. The display 30 may alternatively have, on its periphery, at least one of the cutouts 91 and 92 illustrated in FIG. 12 as examples. The shape of the display 30 will be described later in detail with reference to FIG. 12.

The detecting section 20 includes side-surface touch sensors 21 (side-surface touch detecting section) disposed on the side surface of the casing 31. The side-surface touch sensors 21 each detect a contact with (that is, a touch on) the side surface of the casing 31.

The side-surface touch sensor 21 includes, for example, a plurality of (for example, 16) capacitive sensors arranged in a line on a side surface of the casing 31 The side-surface touch sensor 21 is, however, not limited to such a configuration. The side-surface touch sensor 21 may alternatively be, for example, a sensor of a resistor film type, an infrared type, an ultrasonic type, or an electromagnetic induction coupling type. The side-surface touch sensor 21 will be described later in detail with reference to FIG. 15.

The in-vehicle operation device 1 is capable of sensing a contact with the side surface of the casing 31 (display 30) through the side-surface touch sensors 21 disposed on the side surface of the casing 31. The side-surface touch sensors 21 may each be capable of sensing a contact with the edge (outer edge) of the display 30. The form of the side-surface touch sensors 21 is not limited to that illustrated in, for example, (b) of FIG. 9 as an example. The side-surface touch sensors 21 may each have any form as long as the side-surface touch sensors 21 are each capable of sensing a touch on the side surface of the casing 31 of the in-vehicle operation device 1.

The control section 10 centrally controls the individual sections included in the in-vehicle operation device 1. The control section 10 illustrated in FIG. 8 includes, as functional blocks, a touch sensor controller 11, a process identifying section 12, a process performing section 13, and a display control section 14. The above functional blocks of the control section 10 can each be realized by, for instance, a central processing unit (CPU) or the like reading a program from a storage device including a read only memory (ROM), a non-volatile random access memory (NVRAM), or the like to a random access memory (RAM) or the like (not shown) and executing the program. The description below deals with the individual functional blocks of the control section 10 in detail.

The touch sensor controller 11 includes a touch position locating section 111, and on the basis of the result of a side-surface touch sensor 21 detecting a contact by an object with the side-surface touch sensor 21, locates the position of the contact by the object with the side-surface touch sensor 21. The touch position locating section 111 transmits, to the process identifying section 12, information on the position of the contact by the object with the side-surface touch sensor 21.

The process identifying section 12, on the basis of information on the position of a contact by an object with a side-surface touch sensor 21 which position has been located by the touch position locating section 111 of the touch sensor controller 11, identifies content of a process to be carried out which process is associated with the input operation by the user. The process identifying section 12 then transmits, to the process performing section 13 information on the process content identified. The process identifying section 12 may, on the basis of (i) information on the position of a contact by an object with a side-surface touch sensor 21 and (ii) information on a predetermined image that the display control section 14 is causing the display 30 to display, identify content of a process to be carried out which process is associated with the input operation by the user.

The process performing section 13, on the basis of information on process content which information has been received from the process identifying section 12, causes a corresponding block of the control section 10 (in particular, the display control section 14) to carry out a process corresponding to the process content. The process performing section 13, on the basis of information on process content which information has been received from the process identifying section 12, causes a control target device 50 to carry out a process corresponding to the process content. In a case where, for instance, the process identifying section 12 has identified a touch detected by a side-surface touch sensor 21 as a user operation for raising the set temperature of the air conditioner, the process performing section 13 raises the set temperature to cause the air conditioner to operate on the basis of the set temperature.

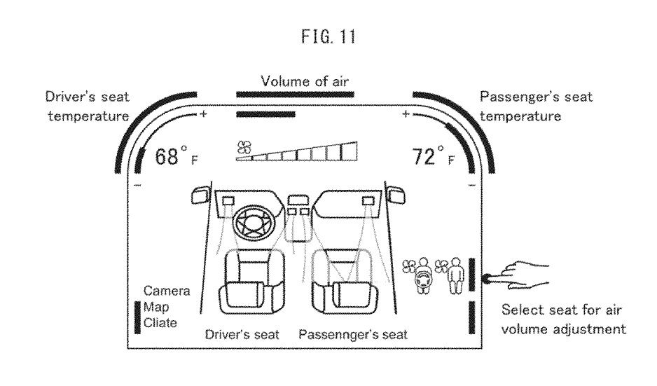

The display control section 14 carries out control for causing the display 30 to display a predetermined image. Images that the display control section 14 causes the display 30 to display will be described later in detail with reference to FIGS. 11, 13, and 14. The display control section 14 may cause the display 30 to display information indicative of a touch position that a side-surface touch sensor 21 is capable of detecting. The display control section 14 may, for instance, cause the display 30 to display, at a portion thereof that is slightly inward of the periphery of the display 30, an image of a curve or a belt to indicate a touch position on the side surface of the casing 31 which touch position can be detected by a side-surface touch sensor 21. The display control section 14 may cause the display 30 to display information indicative of the position of a touch on the side surface of the casing 31 which position has been detected by a side-surface touch sensor 21. The display control section 14 may, for instance, (i) cause the display 30 to display a curve indicative of a touch position on the side surface of the casing 31 which touch position can be detected by a side-surface touch sensor 21, and in a case where the side-surface touch sensor 21 has detected a touch, (ii) change the image at the position on the curve which position corresponds to the position detected. The display control section 14 may alternatively cause the display 30 to display a pointer or the like, indicative of a touch position detected by a side-surface touch sensor 21, in such a mariner that the pointer or the like overlaps with the curve. Causing the display 30 to display (i) information indicative of a touch position on the side surface of the casing 31 which touch position can be detected by a side-surface touch sensor 21 and (ii) information indicative of a touch position on the side surface of the casing 31 which touch position has been detected by a side-surface touch sensor 21 allows a person other than the person who is performing a touching operation to recognize which position on the side surface of the casing 31 the person who is performing the touching operation is touching. The above configuration, in other words, allows a person other than the person who is performing a touching operation to, by looking in the screen of the display 30, check what operation the person who is performing the touching operation is performing. In a case where, for instance, the driver is touching the side surface of the casing 31 of the in-vehicle operation device 1, a person sitting in the passenger's seat can check the image on the display 30 to know which position on the side surface of the casing 31 the driver is touching to operate the in-vehicle operation device 1.

The storage section 40 is a storage device for storing various data that the in-vehicle operation device 1 uses. The storage section 40 is configured to store the following data in a non-temporary manner: (1) control programs (not shown) that the control section 10 executes, (2) an OS program 41 that the control section 10 executes, (3) application programs 42 that the control section 10 executes to carry out various functions of the in-vehicle operation device 1, and (4) various data that the control section 10 reads to execute the application programs. The storage section 40 also stores information such as (5) information 43 on a graphical user interface (GUI) that the display 30 displays. The above data (1) to is stored in a nonvolatile storage device such as a read only memory (ROM), a flash memory, an erasable programmable ROM (EPROM), an electrically erasable programmable ROM (EEPROM [registered trademark]), or a hard disk drive (HDD). The in-vehicle operation device 1 may include a temporary storage section (not shown). The temporary storage section is a working memory configured to temporarily store (i) data that the in-vehicle operation device 1 uses for operations in carrying out various processes and (ii) the results of the operations. The temporary storage section includes a volatile storage device such as a random access memory (RAM). What data is to be stored in what storage device is determined as appropriate in view of the purpose of use of the in-vehicle operation device 1, convenience, cost, physical constraint, and/or the like. The storage section 40 is configured to further store various pieces of information that is generated by the above sections as the in-vehicle operation device 1 is operated. Such pieces of information generated include, for example, information on a touch position located by the touch position locating section 111 of the touch sensor controller 11.

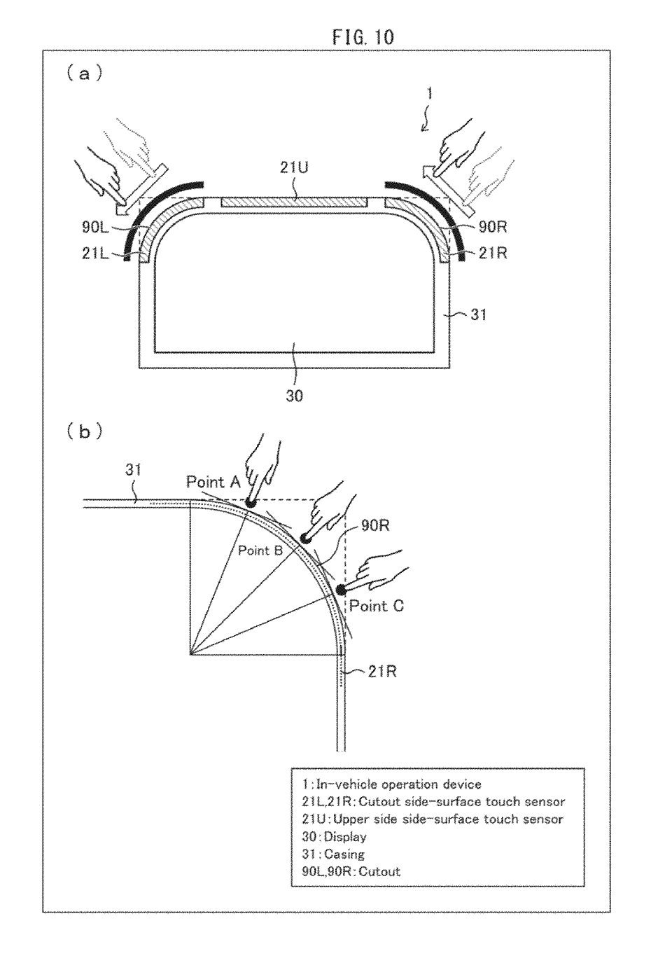

With reference to FIG. 10, the following description will discuss operations (inputs) on the above-detailed in-vehicle operation device 1.

(Operations on In-Vehicle Operation Device 1)

FIG. 10 shows diagrams illustrating example operations on the in-vehicle operation device 1. (a) of FIG. 10 is a diagram illustrating an operation of sliding a finger touching a side-surface touch sensor 21 of the in-vehicle operation device 1. As illustrated in (a) of FIG. 10 as an example, the side-surface touch sensors 21 are each disposed on a circular-arc-shaped portion of the side surface of the casing 31 which circular-arc-shaped portion has a sufficiently large radius of curvature (R). Thus, in a case where the user has touched a portion of the side surface of the casing 31, the user can, without looking at the touched position, feel how the surface of the touched portion is inclined in such a manner as to extend along the periphery of the display 30 (that is, the angle formed by the surface and the horizontal direction as an example reference). Thus, the user can, by means of the feel, guess which position the user has touched. Further, the user can, by sliding a finger touching a portion of the side surface at which portion a side-surface touch sensor 21 is disposed, operate the in-vehicle operation device 1 as if to rotate a dial.

The user can operate the in-vehicle operation device 1 as in an analog manner by, instead of rotating a jog dial (for example, an air conditioning dial for adjusting the set temperature), moving a finger along a portion of the side surface of the casing 31 of the in-vehicle operation device 1 which portion extends along a cutout 90 of the display 30. The user can also tap on a side-surface touch sensor 21 to turn the in-vehicle operation device 1 on and off as if the side-surface touch sensor 21 is a selecting switch such as a power switch.

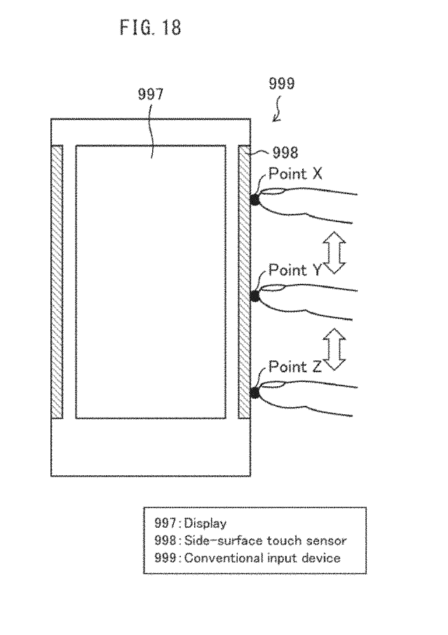

The in-vehicle operation device 1 includes side-surface touch sensors 21 each at a specially shaped portion of the side surface of the casing 31. The in-vehicle operation device 1 can thus provide, to a user touching the side surface of the casing 31, an operation feel different from an operation feel that a user will have in a case where the user touches the side-surface touch sensor 998 disposed on a linear side surface of the conventional input device 999 including a rectangular display 997 as illustrated in FIG. 18.

(b) of FIG. 10 is a diagram illustrating how the feel that the user experiences varies according to the position of a touch on a side-surface touch sensor 21 of the in-vehicle operation device 1. Referring to (b) of FIG. 10, the angle that the user feels varies between (i) a case where the user has touched the point A, (ii) a case where the user has touched the point B, and (iii) a case where the user has touched the point C. If the radius of curvature is small, the user will be unable to distinguish between the point A, point B, and point C by only means of the feel that the user experiences when touching the side surface of the casing 31.

As illustrated in FIG. 18, the input device 999 includes a rectangular display 997, a casing in the shape of a rectangular, flat plate which casing houses the display 997, and a side-surface touch sensor 998 on a side surface of the casing. The input device 999 only assumes that the user operates the input device 999 while looking at the input device 999. The side-surface touch sensor 998 extends in a straight line to be parallel to the periphery of the display 997. Thus, the user experiences almost the same sensation (feel) no matter which position on the side surface of the casing of the input device 999 the user touches. The user is, without looking at the input device 999, unable to recognize which position the user is touching. For instance, in FIG. 18, the feel experienced by the user differs little between a case where the user has touched a point X on the side surface of the casing of the input device 999, a case where the user has touched a point Y on the side surface, and a case where the user has touched a point Z on the side surface. Therefore, it is impossible for the user to know without looking at the input device 999 that for instance, the user has touched the point X, not the point Y or the point Z.

The in-vehicle operation device 1 is, in contrast, configured such that a user having touched a curved portion of the side surface of the casing 31 (that is, the periphery of the display 30) can, without looking at the in-vehicle operation device 1 and by means of the sensation (feel) that the user experiences when touching the side surface of the casing 31, guess the touch position and recognize the distance over which the user has slid a finger.

The in-vehicle operation device 1 also determines whether it has detected a touch on the cutout side-surface touch sensor 21R or 21L. The in-vehicle operation device 1 is thus capable of, in a case where it has detected a touch on the cutout side-surface touch sensor 21L (that is, the side-surface touch sensor 21 disposed on the side of the driver's seat in the example illustrated in (b) of FIG. 9), carrying out a process for the side of the driver's seat (for example, process of setting the set temperature of the air conditioner for the side of the driver's seat) and in a case where the in-vehicle operation device 1 has detected a touch on the cutout side-surface touch sensor 21R (that is, the side-surface touch sensor 21 disposed on the side of the passenger's seat in the example illustrated in (b) of FIG. 9), carrying out a process for the side of the passenger's seat (for example, a process of setting the set temperature of the air conditioner for the side of the passenger's seat).

Specifically, the in-vehicle operation device 1 is disposed between the side of the driver's seat and the side of the passenger's seat of the vehicle 100 as illustrated in (a) of FIG. 9. The cutout side-surface touch sensors 21L and 21R (side-surface touch detecting section) are disposed on the side surface (corresponding to the casing side surface 31S in FIG. 15) of the casing 31 on the side of the driver's seat and on the side of the passenger's seat, respectively. The predetermined process associated with a touch on the cutout side-surface touch sensor 21L (which is disposed on the side of the driver's seat) may be different from the predetermined process associated with a touch on the cutout side-surface touch sensor 21R (which is disposed on the side of the passenger's seat).

With the above configuration, the in-vehicle operation device 1 allows (i) the user in the driver's seat to touch the cutout side-surface touch sensor 21L for a predetermined process set for the user in the driver's seat to be carried out and (ii) the user in the passenger's seat to touch the cutout side-surface touch sensor 21R for a predetermined process set for the user in the passenger's seat to be carried out. The in-vehicle operation device 1 thus allows the user to (i) touch the cutout side-surface touch sensor 2IL (which is disposed on the side of the driver's seat) for a predetermined process associated with a touch on the cutout side-surface touch sensor 21L to be carried out and (ii) touch the cutout side-surface touch sensor 21R (which is disposed on the side of the passenger's seat) for a predetermined process associated with a touch on the cutout side-surface touch sensor 21R to be carried out.

The following description will discuss the casing 31 of the in-vehicle operation device 1 in detail. The casing 31 has, on its periphery, at least one of the curved portions 80, 81, 82, and 83 as illustrated in FIG. 12 as examples which at least one extends along the periphery of the display 30. The casing 31 may have, on its periphery, at least one of the cutouts 90, 91, and 92 as illustrated in FIGS. 9 and 12 as examples. The curved portions 80, 81, 82, and 83 or cutouts 90, 91, and 92 each have a peripheral line that is curved enough for a user having touched that portion of the side surface of the casing 31 which extends along the curved portions 80, 81, 82, and 83 or cutouts 90, 91, and 92 to perceive the touch position by means of the feel.

In other words, the curved portions 80, 81, 82, and 83 or cutouts 90, 91, and 92 of the casing 31 (display 30) each have a peripheral side that varies enough for a user having touched a portion of the side surface extending in the direction of the depth of the display 30 which portion corresponds to the peripheral side to perceive the touch position by means of the feel.

With the above configuration, the curved portions 80, 81, 82, and 83 or cutouts 90, 91, and 92 each have a curve, that is, a variation in shape due to a positional difference, that is large enough for a user having touched the side surface of the casing 31 (display 30) to perceive the touch position by means of the feel. In other words, the feel that the user experiences when touching a position on the side surface of the casing 31 is large enough for the user to perceive the touch position. The above configuration thus allows the user to, by means of the feel, perceive a touch position and cause the in-vehicle operation device 1 to carry out a predetermined process associated with the touch position.

Specifically, the curved portions 80, 81, 82, and 83 or cutouts 90, 91, and 92 preferably each have a peripheral line that has a curve (for example, a radius of curvature (R)) of not less than 10 mm and not more than 500 mm. A radius of curvature (R) within this range allows the user to, without looking at the touched position, easily feel the angle formed by the surface of the touched position and the horizontal direction. This in turn allows the user to, even in a case where the user has touched a position on the basis of the feel, easily recognize which position the user has touched.

(Example Image Displayed on In-Vehicle Operation Device 1)

FIG. 11 is a diagram illustrating an example image displayed by the display 30 of the in-vehicle operation device 1. Specifically, FIG. 11 is a diagram illustrating how the user operates the in-vehicle operation device 1 to control the operation of the air conditioner. The example illustrated in FIG. 11 shows that the user can touch the side-surface touch sensor 21 on the side of the driver's seat (specifically, the cutout side-surface touch sensor 21L) with a finger and slide the finger to control the air conditioner and adjust the temperature on the side of the driver's seat (to 68° F. in the example illustrated in FIG. 11). The example illustrated in FIG. 11 also shows that the user can touch the side-surface touch sensor 21 on the side of the passenger's seat (specifically, the cutout side-surface touch sensor 21R) to control the air conditioner and adjust the temperature on the side of the passenger's seat (to 72° F. in the example illustrated in FIG. 11). This means that in a case where the user wants to have different settings for the side of the driver's seat and the side of the passenger's seat (for instance, the user wants to set the air conditioner to different set temperatures for the side of the driver's seat and the side of the passenger's seat), the user can do so by touching each rounded corner of the side surface of the casing 31 which rounded corner is closer to the intended seat than to the other seat.

The in-vehicle operation device 1 may be configured such that the user touches the side-surface touch sensor 21 on the side of the driver's seat (in the example illustrated in (b) of FIG. 9, the cutout side-surface touch sensor 21L) for a simple operation (for example, an operation to change the magnification of a map displayed by the car navigation system) and that the user touches the side-surface touch sensor 21 on the side of the passenger's seat (in the example illustrated in of FIG. 9, the cutout side-surface touch sensor 21R) for a complex operation (for example, an operation to switch between different recommended routes or change a location to pass through or the destination in the car navigation system). With a simple function assigned to the side-surface touch sensor 21 on the side of the driver's seat, the driver can, in a case where the driver wants to operate the in-vehicle operation device 1 without looking at the in-vehicle operation device 1, easily operate the in-vehicle operation device 1 for the simple function to be carried out. The side-surface touch sensor 21 on the side of the passenger's seat ay be used for a complex operation, as a person sitting in the passenger's seat can operate the in-vehicle operation device 1 while looking at the in-vehicle operation device 1. The in-vehicle operation device 1 may, in other words, be configured to carry out different processes between (i) a case where the in-vehicle operation device 1 has detected a touching operation for the side-surface touch sensor 21 on the side of the driver's seat and a case where the in-vehicle operation device 1 has detected a touching operation for the side-surface touch sensor 21 on the side of the passenger's seat.

The in-vehicle operation device 1 includes side-surface touch sensors 21 each disposed on the side surface of a display 30 (more precisely, a casing 31) shaped to have a periphery whose angle varies gently. With this configuration, in a case where the user wants to touch a rounded corner (that is, a circular-arc-shaped portion whose orientation varies gently; cutout 90) of the side surface of the casing 31 (display 30) with a finger and slide the finger to operate the in-vehicle operation device 1 (for instance, to adjust the set temperature of the air conditioner gradually), the user can operate the in-vehicle operation device 1 on the basis of the feel, without carefully looking at the touch position.

The user can also touch the side-surface touch sensor 21 disposed on an upper-side portion of the side surface of the casing 31 (specifically, the upper side side-surface touch sensor 21U) to adjust the volume of air. The user can tap on a lower right portion (in FIG. 11) of the cutout side-surface touch sensor 21R to select a seat for which the volume of air is to be adjusted.

The description above has dealt with an example involving a display 30 having cutouts 90. It is, however, not essential for the display 30 to have a shape as illustrated in FIGS. 9 to 11 (that is, a shape with rounded corners). The shape of the display 30 (that is, the shape of the casing 31 housing the display 30) may be any shape as long as the user can, when touching the side surface of the display 30 (more precisely, the casing 31), feel an angle corresponding to the touch position. FIG. 12 illustrates examples of the shape of the display 30 that allow the user to, when touching the side surface of the display 30 (more precisely, the casing 31), feel an angle corresponding to the touch position.

(Shape of Display 30)

FIG. 12 shows diagrams each illustrating an example of the shape of the display 30 of the in-vehicle operation device 1. (a) of FIG. 12 is a diagram illustrating a display 30 having a curved portion 80, which is in the shape of a circular arc equivalent to a half of the circumference of a circle (or ellipse). The display 30 illustrated in (a) of FIG. 12 as an example is, in other words, substantially in the shape of a half of a circle (or ellipse). (b) of FIG. 12 is a diagram illustrating a display 30 having a curved portion 81, which is in the shape of a circular arc equivalent to a quarter of the circumference of a circle ellipse). The display 30 illustrated in (b) of FIG. 12 as an example is, in other words, in the shape of a quadrant. (c) of FIG. 12 is a diagram illustrating a display 30 having a curved portion 82, which is in the shape of a circular arc equivalent to the circumference of a circle (or ellipse). The display 30 illustrated in (c) of FIG. 12 as an example is, in other words, in the shape of a circle (or ellipse).

(d) of FIG. 12 is a diagram illustrating a display 30 having cutouts 91. Specifically, the display 30 has two upper corners of its rectangle cut out each in the shape of a sector. (e) of FIG. 12 is a diagram illustrating a display 30 having cutouts 92. Specifically, the display 30 has two upper corners of its rectangle cut out each in the shape of a triangle. Since the peripheral shape of the display 30 only needs to allow the user to, when touching the side surface of the casing 31, recognize a difference in sensation (feel) according to the touch position, the peripheral shape is, as illustrated in (e) of FIG. 12, not necessarily curved. The display 30 may, for example, have a peripheral shape having consecutive straight lines whose respective inclinations vary in stages. The display 30 may have, for example, a polygonal peripheral shape having more than four sides including two adjacent sides that form an angle of more than 90 degrees.

(f) of FIG. 12 is a diagram illustrating a display 30 having a plurality of curved portions 83. The display 30 of the example illustrated in (f) of FIG. 12 has two curved portions 83. The display 30 may alternatively have three or more curved portions 83.

The shape of the display 30 is not limited to the examples illustrated in (a) to (f) of FIG. 12. The display 30 may have any shape that allows the user to, when touching the side surface of the display 30 (more precisely, the casing 31), feel an angle corresponding to the touch position.

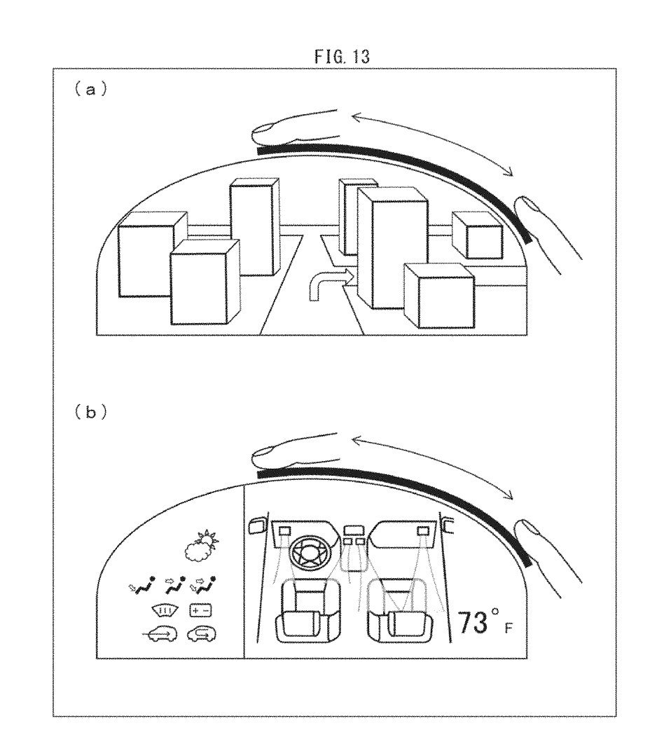

With reference to FIG. 13, the following description will discuss operations on an in-vehicle operation device including a display 30 having a substantially semicircular shape (D shape).

FIG. 13 shows diagrams illustrating example operations on an in-vehicle operation device 1 including a substantially semicircular display 30, that is, a display 30 having a curved portion 80 illustrated in (a) of FIG. 12 as an example.

(a) of FIG. 13 is a diagram illustrating how the user operates the in-vehicle operation device 1 to cause the car navigation system to carry out a predetermined process. Specifically, as illustrated in (a) of FIG. 13, the user can touch the cutout side-surface touch sensor 21R with a finger and slide the finger to, for example, adjust the angle of the view (that is, the visual angle or viewpoint) displayed by the car navigation system. The in-vehicle operation device 1 may be configured to allow the user to operate the in-vehicle operation device 1 in order to select a destination on the car navigation system. The in-vehicle operation device 1 may alternatively be configured to allow the user to operate the in-vehicle operation device 1 in order to change the magnification of a map displayed by the car navigation system and/or switch between a 3D map and a 2D map on the car navigation system.

(b) of FIG. 13 is a diagram illustrating how the user operates the in-vehicle operation device 1 to cause the air conditioner to carry out a predetermined process. Specifically, as illustrated in (b) of FIG. 13, the user can touch the cutout side-surface touch sensor 21R with a finger and slide the finger to, for example, change the set temperature of the air conditioner. The in-vehicle operation device 1 may be configured to allow the user to operate the in-vehicle operation device 1 in order to adjust the volume of air from the air conditioner.

The in-vehicle operation device 1 may be configured such that the user can touch, with a finger, a side-surface touch sensor 21 disposed on the side surface of the casing 31 of the in-vehicle operation device 1 and slide the finger to, for example, scroll a screen image displayed by the display 30.

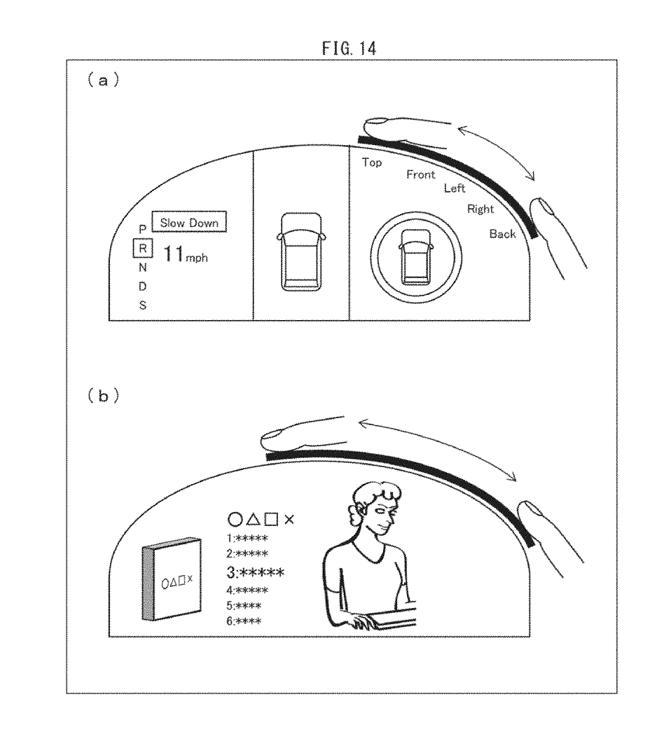

FIG. 14 shows diagrams illustrating other example operations on an in-vehicle operation device 1 including a substantially semicircular display 30.

(a) of FIG. 14 is a diagram illustrating how the user operates the in-vehicle operation device 1 to cause a camera (for example, an in-vehicle camera) to carry out a predetermined process. Specifically, as illustrated in (a) of FIG. 14, the user can touch the cutout side-surface touch sensor 21R with a finger and slide the finger to, for example, adjust the visual angle and/or viewpoint of the camera.

(b) of FIG. 14 is a diagram illustrating how the user operates the in-vehicle operation device 1 to cause in-vehicle audio equipment to carry out a predetermined process. Specifically, as illustrated in (b) of FIG. 14, the user can touch the cutout side-surface touch sensor 21R with a finger and slide the finger to, for example, select a piece of music to be played by the in-vehicle audio equipment. The in-vehicle operation device 1 may be configured to allow the user to operate the in-vehicle operation device 1 in order to switch channels of car radio output and change the loudspeaker volume and/or the like.

As described above with reference to FIGS. 13 and 14 as examples, the user can operate the in-vehicle operation device 1 to cause various devices (control target devices 50) related to the vehicle 100 and/or applications to each carry out a predetermined process. Specifically, FIGS. 13 and 14 illustrate examples each involving a car navigation system, an air conditioner, a camera (in-vehicle camera), or in-vehicle audio equipment as a control target device 50. Predetermined processes to be carried out through an operation by the user of the in-vehicle operation device 1 are not limited to the examples above. The in-vehicle operation device 1 may alternatively he configured such that the user can operate the in-vehicle operation device 1 to, for example, (i) select an application to be executed by the in-vehicle operation device 1, (ii) select a contact address in a telephone hook, (iii) control the amount of opening and closing of a door or sunroof, and (iv) adjust the interval of the intermittent wiper.

The in-vehicle operation device 1 preferably has a narrow frame. More specifically, that surface of the casing 31 which covers the periphery of the display 30 and which is substantially parallel to the display 30 is preferably narrow. Such a narrow frame ensures a large screen and thus allows a displayed image to be seen easily. Further, in a case where the display control section 14 causes the display 30 to display (i) information indicative of a touch position on the side surface of the casing 31 which touch position can be detected by a side-surface touch sensor 21 and (ii) information indicative of the position of a touch on the side surface of the casing 31 which position has been detected by a side-surface touch sensor 21, the in-vehicle operation device 1 having a narrow frame allows the user to more easily recognize a detectable touch position and a detected touch position.

Since the user can operate the in-vehicle operation device 1 by sliding a finger touching a side-surface touch sensor 21 disposed on the side surface of the casing 31 of the in-vehicle operation device 1, the user can operate the in-vehicle operation device 1 intuitively as if to rotate a dial. The in-vehicle operation device 1 may be configured such that in a case where the in-vehicle operation device 1 has accepted an operation by the user of sliding a finger touching a side-surface touch sensor 21, the in-vehicle operation device 1 carries out processes that are different between (i) a case where that side-surface touch sensor 21 is the cutout side-surface touch sensor 21L (that is, the side-surface touch sensor 21 on the side of the driver's seat) and (ii) a case where that side-surface touch sensor 21 is the cutout side-surface touch sensor 21R (that is, the side-surface touch sensor 21 on the side of the passenger's seat). The user can, by touching a portion of the side surface of the casing 31 which portion extends along a cutout 90 (corner) of the display 30, operate the in-vehicle operation device 1 without looking at the in-vehicle operation device 1 or with only a moment look at the in-vehicle operation device to cause a control target device 50 such as the air conditioner to carry out a predetermined process.

With reference to FIG. 15, the following description will discuss an example of how a side-surface touch sensor 21 is actually formed on the side surface of the casing 31, which has a curved periphery, that is, at least one of the curved portions 80, 81, 82, and 83 and cutouts 90, 91, and 92.

(Example of Actual Side-Surface Touch Sensor 21)

FIG. 15 shows diagrams illustrating an example of sensor electrodes 211 disposed on the casing 31 of the in-vehicle operation device 1 to form a side-surface touch sensor 21. As illustrated in FIG. 15, the casing 31 includes (i) a casing bottom surface 31F, that is a bottom surface portion of the casing 31, and (ii) a casing side surface 31S, that is, a side surface portion of the casing 31. The plurality of sensor electrodes 211 are disposed next to each other on the inner side of the casing side surface 31S (that is, on the side on which the display 30 is present), and detect a touch on the casing side surface 31S. Specifically, FIG. 15 illustrates an example involving a sensor electrode 211a and a sensor electrode 211b that are disposed next to each other at a predetermined interval L and that are positioned between a plurality of casing ribs 31R on the inner side of the casing side surface 31S. The plurality of casing ribs 31R form a clearance between (i) the sensor electrodes 211 and (ii) the display 30 incorporated in the casing 31. Specifically, as illustrated in FIG. 8 as an example, the plurality of casing ribs 31R are present on the inner side of the casing side surface 31S and each protrude from the inner surface of the casing side surface 31S toward the peripheral edge of the display 30 by a predetermined thickness T. The plurality of sensor electrodes 211 (for example, the sensor electrode 211a and sensor electrode 211b) are each positioned between two of the plurality of casing ribs 31R. The predetermined thickness T of each casing rib 31R is, for example, 0.5 mm. The sensor electrodes 211 each have a thickness of, for example, 0.1 mm. In this example, there is a clearance of approximately 0.4 mm between (i) the respective surfaces of the sensor electrodes 211 and (ii) the peripheral edge of the display 30. The plurality of sensor electrodes 211 each have a reliable sensitivity, with (i) the casing side surface 31S having, on the inner side, a plurality of casing ribs 31R each protruding toward the peripheral edge of the display 30 by a predetermined thickness T and (ii) the sensor electrodes 211 positioned between the casing ribs 31R.

Each casing rib 31R has a width of, for example, 1 mm; in other words, the predetermined interval L between the sensor electrode 211a and the sensor electrode 211b is, for example, 1 mm. Arranging the plurality of sensor electrodes 211 next to each other at the predetermined interval makes it possible to locate the position of a touch on the casing side surface 31S.

(Mounting In-Vehicle Operation Device 1 for Back Seat)

The description above has dealt with an example of the in-vehicle operation device 1 being mounted for a front seat (that is, a seat present on the side on which the driver's seat and the passenger's seat are present) of the vehicle 100. The in-vehicle operation device 1 may, however, be mounted at any position in the vehicle 100, for example, on the back surface of a front seat.

### Embodiment 5

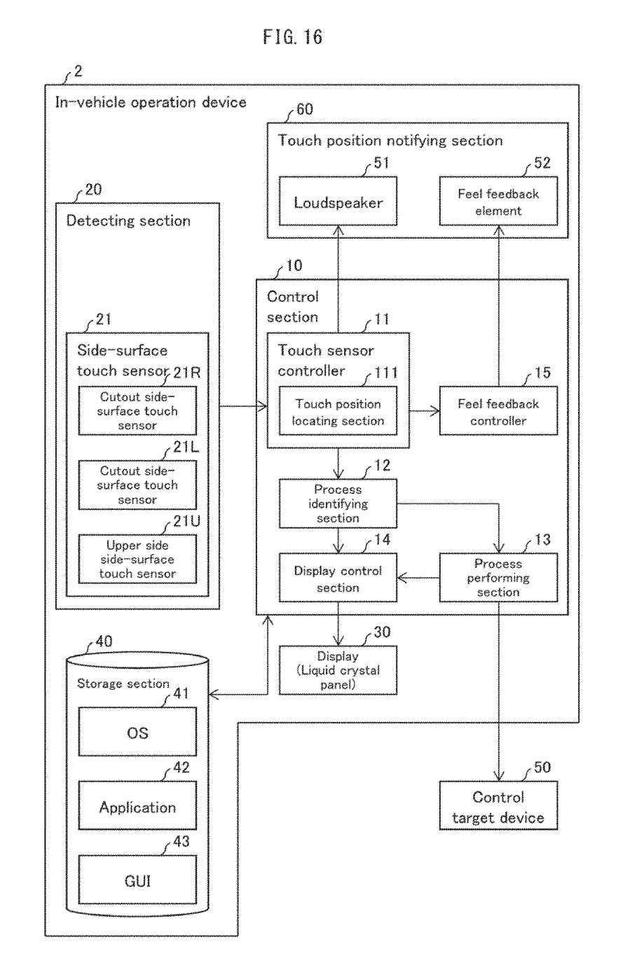

The following description will discuss still another embodiment of the present invention with reference to FIG. 16.

The description below first outlines an in-vehicle operation device 2 in accordance with Embodiment 5 of the present invention. The in-vehicle operation device 2 includes a touch position notifying section 60 (touch notifying section) configured to notify the user that a side-surface touch sensor 21 (side-surface touch detecting section) has detected a touch.

With the above configuration, the touch position notifying section 60 notifies the user that a side-surface touch sensor 21 has detected a touch. This allows the user to recognize that the user has touched a predetermined position on the in-vehicle operation device 2 and to, for example, recognize that the in-vehicle operation device 2 has accepted an operation by the user for causing the in-vehicle operation device 2 to carry out a predetermined process. The description below deals with the in-vehicle operation device 2 in detail with reference to FIG. 16.

FIG. 16 is a block diagram illustrating an example configuration of main sections of the in-vehicle operation device 2. The in-vehicle operation device 2 in FIG. 16 is configured as the in-vehicle operation device 1 in FIG. 1, and further includes a feel feedback controller 15 and a touch position notifying section 60.

The touch position notifying section 60 includes a loudspeaker 51 and a feel feedback element(s) 52. The touch position notifying section 60 notifies the user that a side-surface touch sensor 21 has detected a touch. The touch position notifying section 60 should desirably notify the user of a touch position detected by the side-surface touch sensor 21. The touch position notifying section 60 of the present embodiment includes at least one of the loudspeaker 51 and the feel feedback element 52. The touch position notifying section 60 may, however, include an element(s) other than the loudspeaker 51 or feel feedback element 52. The touch position notifying section 60 may, in other words, have any configuration as long as it is capable of notifying the user that a side-surface touch sensor 21 has detected a touch.

The feel feedback controller 15, upon notification from the touch sensor controller 11 that a side-surface touch sensor 21 has detected a touch, instructs the feel feedback element to, for example, cause vibrations and generate static electricity. In particular, in a case where the feel feedback controller 15 has been notified by the touch position locating section 111 of the position of a contact by an object with a side-surface touch sensor 21, the feel feedback controller 15 instructs a feel feedback element 52 disposed at a position corresponding to the contact position to, for example, cause vibrations and generate static electricity.

The feel feedback element 52 is disposed on the side surface of the casing 31 (which houses the display 30) similarly to the side-surface touch sensors 21. The feel feedback element 52, for example, vibrates or generates static electricity at a position touched by the user or a position close to the touched position. In a case where the feel feedback element 52 is to, for example, vibrate in order to provide the user with feedback about a touch, the feel feedback element 52 can be, for example, an eccentric rotating mass (ERM), a linear resonant actuator (LRA), or a piezoelectric element. Examples of the feel feedback element 52 are not limited to the above. The feel feedback element 52 may be any element based on a well-known haptic technology as appropriate.

The loudspeaker 51 outputs a sound upon notification from the touch sensor controller 11 that a side-surface touch sensor 21 has detected a touch. In particular, in a case where the loudspeaker 51 has been notified by the touch position locating section 111 of the position of a contact by an object with a side-surface touch sensor 21, the loudspeaker 51 outputs a sound corresponding to the contact position to notify the user of the contact position. In a case where, for instance, different points on the side surface of the casing 31 are each associated in advance with a predetermined sound, the loudspeaker 51 outputs a sound associated with a contact position (touch position) of which the touch position locating section 111 has notified the loudspeaker 51.

The in-vehicle operation device 2 is configured to, in a case where the user has touched the side surface of the casing 31, provide the user with feedback corresponding to the touch by means of, for example, vibration and static electricity. This allows the user to experience a stronger sensation from a touch on the side surface of the casing 31.

### Embodiment 6

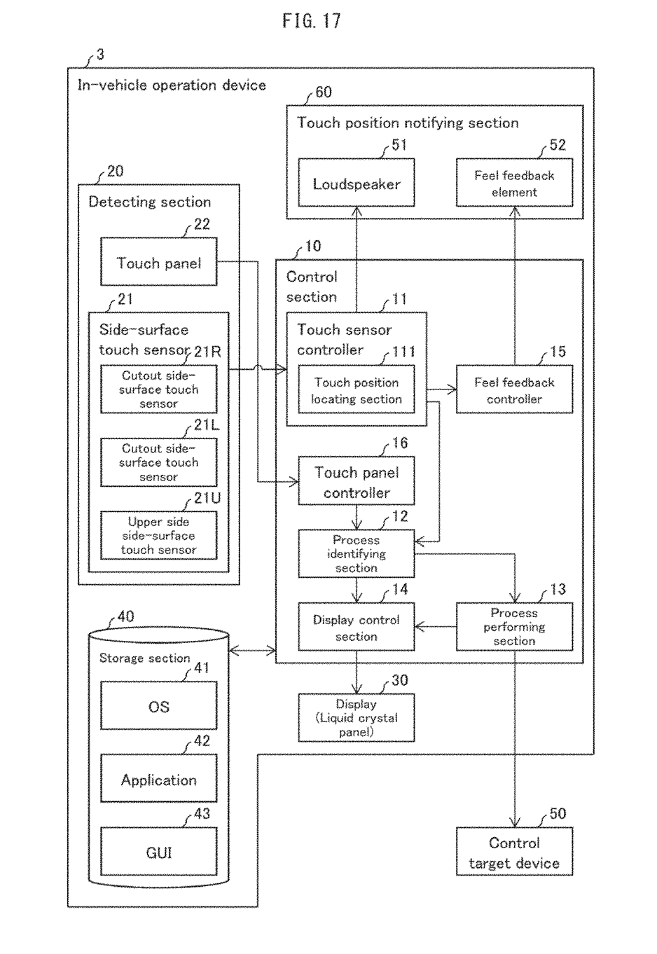

The following description will discuss still another embodiment of the present invention with reference to FIG. 17

The description below first outlines an in-vehicle operation device 3 in accordance with Embodiment 6 of the present invention. The in-vehicle operation device additionally includes a touch panel 22 disposed on the display 30 (display screen) and configured to detect a touching operation by the user for the display 30.

With the above configuration, the touch panel 22 detects a touching operation by the user for the display 30. This allows the user to touch the touch panel 22 to cause the in-vehicle operation device 3 to carry out a predetermined process. The functions so assigned as to be carried out through an operation by the user on the touch panel 22 may entirely or partly be so assigned as to be carried out through an operation by the user on a side-surface touch sensor 21. Further, the function(s) so assigned as to be carried out through an operation by the user on the touch panel 22 may differ from the function(s) so assigned as to be carried out through an operation by the user on a side-surface touch sensor 21. The description below deals with the in-vehicle operation device 3 in detail with reference to FIG. 17.

FIG. 17 is a block diagram illustrating an example configuration of main sections of the in-vehicle operation device 3. The in-vehicle operation device 3 in FIG. 17 is configured as the in-vehicle operation device 2 in FIG. 8, and further includes a touch panel controller 16 and a touch panel 22. Specifically, the detecting section 20 of the in-vehicle operation device 3 includes a touch panel 22 on the display 30 in addition to side-surface touch sensors 21 disposed on the side surface of the casing 31 of the in-vehicle operation device 1 which side surface extends along the outer edge of the display 30. The touch panel 22 detects a contact by an object within the display screen of the display 30 housed by the casing 31. The touch panel 22 is, for example, a capacitive touch panel. The touch panel 22 is, however, not limited to this example. The touch panel 22 may alternatively be, for example, a touch panel of a resistor film type, an infrared type, an ultrasonic type, or an electromagnetic induction coupling type.

The touch panel controller 16, on the basis of the result of the touch panel 22 detecting a contact by an object within the display screen of the display 30, locates the position (coordinates) of the contact by the object within the display screen. The touch panel controller 16 then transmits, to the process identifying section 12, information on the position of the contact by the object with the touch panel 22.

The touch sensor controller 11 (more specifically, the touch position locating section 111) of the in-vehicle operation device 3 locates the position of a contact by an object with a side-surface touch sensor 21, and transmits, to the process identifying section 12, information on the position of the contact by the object with the side-surface touch sensor 21.

The process identifying section 12 of the in-vehicle operation device 3, on the basis of at least one of (i) information on the position of a contact by an object within the display screen of the display 30 which position has been located by the touch panel controller 16 and (ii) information on the position of a contact by an object with a side-surface touch sensor 21 which position has been located by the touch position locating section 111 of the touch sensor controller 11, identifies content of a process to be carried out which process is associated with the input operation by the user. The process identifying section 12 then transmits, to the process performing section 13, information on the process content identified. The process identifying section 12 may, on the basis of a combination of (i) information on a predetermined image that the display control section 14 is causing the display 30 to display with (ii) at least one of information on the position of a contact by an object within the display screen of the display 30 and information on the position of a contact by an object with a side-surface touch sensor 21, identify content of a process to be carried out which process is associated with an input operation by the user.

The user operating the in-vehicle operation device 3, which includes not only side-surface touch sensors 21 but also a touch panel 22, can touch a side-surface touch sensor 21 for a simple operation (for example, an operation to change the magnification of a map displayed by the car navigation system) and touch the touch panel 22 for complex operation (for example, an operation to switch between different recommended routes or change a location to pass through or the destination in the car navigation system). The in-vehicle operation device 3 can, in other words, be configured to cause at least one of a side-surface touch sensor 21 and the touch panel 22 to accept an operation in correspondence with the complexity of that operation. The in-vehicle operation device 3 thus allows the user to (touch the touch panel 22 (disposed on the display 30) while looking in the display 30 for a complex operation or an operation that requires preciseness and to (ii) touch a side-surface touch sensor 21 for a simple operation. The in-vehicle operation device 3 therefore offers improved convenience for the user. The in-vehicle operation device 3 may be configured such that one or more of the functions that can be carried out through an operation on the touch panel 22 can be carried out through an operation on a side-surface touch sensor 21.

(Avoiding Conflict Between Processes on the Basis of Comparison of Touch Strengths)

A side-surface touch sensor 21 and the touch panel 22 may detect the same touch simultaneously. In particular, in a case where the in-vehicle operation device 3 has a narrow frame, that is, that surface of the casing 31 which covers the periphery of the display 30 of the in-vehicle operation device 3 and which is substantially parallel to the display 30 is narrow, the possibility is higher that a side-surface touch sensor 21 and the touch panel 22 detect the same touch simultaneously. In a case where a side-surface touch sensor 21 and the touch panel 22 have each detected a touch, the in-vehicle operation device 3 compares the respective touch strengths of the touches detected by the side-surface touch sensor 21 and the touch panel 22 and carries out a predetermined process corresponding to the touch having a higher touch strength. The in-vehicle operation device 3 may compare the respective touch strengths of the touches detected by a side-surface touch sensor 21 and the touch panel 22 with use of, for example, values (for example, capacitance values) indicative of the respective input strengths of touches detected by the side-surface touch sensor 21 and the touch panel 22.

Thus, in a case where a side-surface touch sensor 21 and the touch panel 22 have detected a touch by the user simultaneously, the in-vehicle operation device 3 compares the respective touch strengths of the touches detected by the side-surface touch sensor 21 and the touch panel 22 and carries out a predetermined process corresponding to the touch having a higher touch strength. The in-vehicle operation device 3 is therefore capable of, in a case where there has been a conflict between two or more operations on the in-vehicle operation device 3, selecting one of the conflicting operations to carry out a process corresponding to the selected operation.

[Software Implementation Example]

Control blocks of the rear-view mirror 200 and rear-view mirror 200a (in particular, the control section 10 and control section 10a) and control blocks of the in-vehicle operation devices 1, 2, and 3 (in particular, the touch sensor controller 11, process identifying section 12, process performing section 13, display control section 14, feel feedback controller 15, and touch panel controller 16) can each be realized by a logic circuit (hardware) provided in an integrated circuit (IC chip) or the like or can be alternatively realized by software as executed by a central processing unit (CPU).

In the latter case, the rear-view mirror 200 and rear-view mirror 200a and the in-vehicle operation devices 1, 2, and 3 each include a CPU that executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. An object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be supplied to the computer via any transmission medium (such as a communication network or a broadcast wave) which allows the program to be transmitted. Note that the present invention can also be achieved in the form of computer data signal in which the program is embodied via electronic transmission and which is embedded in a carrier wave.

[Recap]

A mirror in accordance with a first aspect of the present invention (rear-view mirror 200, rear-view mirror 200a) includes: a half mirror section (half mirror 150) having a reflecting surface and a transmitting surface and configured to reflect light incident on the reflecting surface and transmit light incident on the transmitting surface; a display section (display 130) configured to display an image, the display section having a display surface and being disposed on or over the half mirror section in such a manner that the transmitting surface faces the display surface; a casing (casing 310) to which the half mirror section and the display section are assembled, the casing having a side surface (casing side surface 310S) extending along periphery of the half mirror section and a periphery of the display section; and a side-surface touch detecting section (side-surface touch sensor 121) configured to detect a touch by a user on the side surface of the casing.

The above configuration allows a touch by the user to be detected on the side surface of the casing. The mirror thus has a thin frame portion as compared to a mirror including a physical button as an input device. The above configuration eliminates the need to press something down as with a physical button, and can thus provide a mirror that is easy to operate. The above configuration also eliminates the possibility of a mirror surface becoming dirty and consequently having decreased visibility as with a mirror including a touch panel on the mirror surface as an input device. The above configuration can, therefore, provide a mirror that is easy for the user to operate, and ensures the safety of the driver and offers an improved operability at the same time.

A mirror in accordance with a second aspect of the present invention may be configured as in the first aspect and further include a display control section (display control section 114) configured to cause the display section to display or hide the image in correspondence with the touch detected by the side-surface touch detecting section.

The above configuration makes it possible to switch between displaying and not displaying of an image by the display section in correspondence with the touch detected, and thus makes it possible to display or hide an image in accordance with the situation that the user is in.

A mirror in accordance with a third aspect of the present invention may be configured such that in the second aspect, the display control section causes the display section to display the image within a partial region of the display surface.

The above configuration allows a mirror image to be shown in a region of the display surface which region is other than the partial region in which an image is being displayed. This allows the user to use the mirror as a mirror even in a case where an image is being displayed.

A mirror in accordance with a fourth aspect of the present invention may be configured such that in the second or third aspect, the display control section causes the display section to display, on the display surface, an image in a vicinity of a region of the side surface in which region the mirror is configured to accept the touch by the user, the image indicating a position of the region of the side surface.

The above configuration allows an image to be displayed on the display surface of the display section, in the vicinity of a region of the side surface of the casing in which region the mirror is configured to accept a touch by the user, the image indicating the position of the region of the side surface. This allows the user to recognize which region of the side surface of the casing the user can touch for an input operation.

An in-vehicle operation device in accordance with a fifth aspect of the present invention (in-vehicle operation device 1, 2, 3) includes: a display screen (display 30) having a curved portion (80, 81, 82, 83) or cutout portion (cutout 90, 91, 92) on a periphery thereof; a casing (casing 31) to which the display screen is assembled, the casing having a side surface (casing side surface 31S) along the periphery of the display screen, the side surface extending in a direction of depth of the display screen; and at least one side-surface touch detecting section (side-surface touch sensor 21) configured to detect at least a touch by a user on a position on a portion of the side surface of the casing which portion extends along the curved portion or cutout portion of the display screen.

With the above configuration, the casing has periphery that extends along the periphery of the display screen, which has a curved portion or cutout portion on the periphery thereof. Thus, the user, when having touched the side surface of the casing, experiences the feel that varies according to the touch position. This allows the user (for example, the driver) to guess the touch position by means of the feel, in other words, to recognize the touch position without looking at the touch position. The above configuration thus allows even the driver to easily and safely cause the in-vehicle operation device to carry out a predetermined process associated with a touch position. The above configuration thus ensures the safety of the driver and offers an improved operability at the same time.

An in-vehicle operation device in accordance with a sixth aspect of the present invention may be configured such that in the fifth aspect, the curved portion or cutout portion has a peripheral line that is curved enough for the user shown has touched the position to perceive the position by means of feel.

With the above configuration, the curved portion or cutout portion has a curve, that is, a variation in shape due to a positional difference, that is large enough for a user having touched the side surface of the casing to perceive the touch position by means of the feel. The above configuration thus allows the user to, by means of the feel, perceive a touch position and cause the in-vehicle operation device to carry out a predetermined process associated with the touch position.

An in-vehicle operation device in accordance with a seventh aspect of the present invention (in-vehicle operation device 2, 3) may be configured as in the fifth or sixth aspect and further include a touch notifying section (touch position notifying section 60) configured to notify the user that the at least one side-surface touch detecting section has detected a touch.

With the above configuration, the touch notifying section notifies the user that the side-surface touch detecting section has detected a touch. This allows the user to recognize that the user has touched a predetermined position on the in-vehicle operation device and to, for example, recognize that the user has tried to perform an operation for causing the in-vehicle operation device to carry out a predetermined process.

An in-vehicle operation device in accordance with an eighth aspect of the present invention (in-vehicle operation device 1, 2, 3) may be configured such that in any one of the fifth to seventh aspects, the in-vehicle operation device is disposed between a side of a driver's seat of a vehicle (vehicle 100) and a side of a passenger's seat of the vehicle; and the at least one side-surface touch detecting section includes a first side-surface touch detecting section disposed on the side surface of the casing on the side of the driver's seat and a second side-surface touch detecting section disposed on the side surface of the casing on the side of the passenger's seat, a touch for the first side-surface touch detecting section being associated with a first predetermined process and a touch on the second side-surface touch detecting section being associated with a second predetermined process different from the first predetermined process.

With the above configuration, the in-vehicle operation device allows (i) the user in the driver's seat to touch the side-surface touch detecting section disposed on the side of the driver's seat for a predetermined process set for the user in the driver's seat to be carried out and (ii) the user in the passenger's seat to touch the side-surface touch detecting section disposed on the side of the passenger's seat for a predetermined process set for the user in the passenger's seat to be carried out.

An in-vehicle operation device in accordance with a ninth aspect of the present invention (in-vehicle operation device 3) may be configured as in any one of the fifth to eighth aspects and further include a touch panel (touch panel 22) disposed over the display screen and configured to detect a touch by the user for the display screen.

With the above configuration, the touch panel detects a touching operation by the user for the display screen. This allows the user to touch the touch panel to cause the in-vehicle operation device to carry out a predetermined process. The functions so assigned as to be carried out through an operation by the user on the touch panel may entirely or partly be so assigned as to be carried out through an operation by the user on the side-surface touch detecting section. Further, the function(s) so assigned as to be carried out through an operation by the user on the touch panel may differ from the function(s) so assigned as to be carried out through an operation by the user on the side-surface touch detecting section.

An in-vehicle operation device in accordance with a tenth aspect of the present invention may be configured such that in the ninth aspect, in a case where the at least one side-surface touch detecting section and the touch panel have each detected a touch by the user simultaneously, the in-vehicle operation device compares respective touch strengths of the touches detected by the at least one side-surface touch detecting section and the touch panel and carries out a predetermined process corresponding to a first one of the touches of which first one the touch strength is higher than the touch strength of a second one of the touches.

With the above configuration, the in-vehicle operation device is capable of, in a case where the side-surface touch detecting section and the touch panel have each detected a touch by the user simultaneously, carrying out a predetermined process corresponding to the touch having a higher touch strength. The in-vehicle operation device is therefore capable of, in a case where there has been conflict between two or more operations on the in-vehicle operation device, selecting one of the conflicting operations to carry out a process corresponding to the selected operation.

A vehicle in accordance with an eleventh aspect of the present invention (vehicle 300) may include the mirror according to any one of the first to fourth aspects as a rear-view mirror.

With the above configuration, the rear-view mirror mounted in the vehicle detects a touch by the user on the side surface of the casing. The rear-view mirror thus has a thin frame portion and allows the driver to have a wide view ahead of the vehicle, as compared to a conventional rear-view mirror including a physical button as an input device. The above configuration eliminates the need to press something down as with a physical button, and can thus reduce the decrease in the user's concentration on driving which decrease results from performing an input operation The above configuration also eliminates the possibility of a mirror surface becoming dirty and consequently having decreased visibility as with a rear-view mirror including a touch panel on the mirror surface as an input device. The above configuration thus maintains the driving safety even in a case where the user performs an input operation.

A vehicle in accordance with a twelfth aspect of the present invention (vehicle 100) includes the in-vehicle operation device according to any one of the fifth to tenth aspects.

With the above configuration, the vehicle allows the user (for example, the driver) to guess the touch position by means of the feel and cause the in-vehicle operation device to carry out a predetermined process associated with the touch position. This allows even the driver of the vehicle to easily and safely operate the in-vehicle operation device as desired.

The mirrors and in-vehicle operation devices in accordance with the embodiments above of the present invention may each be realized by a computer. In this case, the present invention encompasses in its scope (i) a control program for the mirror or in-vehicle operation device which control program causes a computer to operate as each section (software element) of the mirror or in-vehicle operation device so that the mirror or in-vehicle operation device is realized by a computer and (ii) a computer-readable storage medium storing that control program.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1 In-vehicle operation device

2 In-vehicle operation device

3 In-vehicle operation device

21 Side-surface touch sensor (side-surface touch detecting section)

22 Touch panel

30 Display (display screen)

31 Casing

31S Casing side surface (side surface)

60 Touch position notifying section (touch notifying section)

80 Curved portion

81 Curved portion

82 Curved portion

83 Curved portion

90 Cutout (cutout portion)

91 Cutout (cutout portion)

92 Cutout (cutout portion)

100 Vehicle

114 Display control section

121 Side-surface touch sensor (side-surface touch detecting section)

130 Display (display section)

150 Half mirror (half mirror section)

200 Rear-view mirror (mirror)

200a Rear-view mirror (mirror)

300 Vehicle

310 Casing

310SCasing side surface (side surface)

1. An in-vehicle operation device, comprising:
a display section configured to display an image indicating a process to be carried out;
a casing to which the display section is assembled, the casing having a side surface extending along a periphery of the display section; and
a side-surface touch detecting section configured to detect a touch by a user on the side surface of the casing;
the image being displayed in a vicinity of a partial region of the side surface in which partial region the vehicle operation device is configured to accept the touch by the user, the image indicating a position of the partial region of the side surface,
the partial region being variable.

2-6. (canceled)

7. The in-vehicle operation device according to claim 1, further comprising:
a touch notifying section configured to notify the user that the at least one side-surface touch detecting section has detected a touch.

8. The in-vehicle operation device according to claim 1,
wherein the in-vehicle operation device is disposed between a side of a driver's seat of a vehicle and a side of a passenger's seat of the vehicle; and
the at least one side-surface touch detecting section includes (i) a first side-surface touch detecting section disposed on the side surface of the casing on the side of the driver's seat and (ii) a second side-surface touch detecting section disposed on the side surface of the casing on the side of the passenger's seat, a touch for the first side-surface touch detecting section being associated with a first predetermined process and a touch on the second side-surface touch detecting section being associated with a second predetermined process different from the first predetermined process.

9. The in-vehicle operation device according to claim 1, further comprising:
a touch panel disposed over the display section and configured to detect a touch by the user for the display screen.

10. The in-vehicle operation device according to claim 9,
wherein
in a case where the at least one side-surface touch detecting section and the touch panel have each detected a touch by the user simultaneously, the in-vehicle operation device compares respective touch strengths of the touches detected by the at least one side-surface touch detecting section and the touch panel and carries out a predetermined process corresponding to a first one of the touches of which first one the touch strength is higher than the touch strength of a second one of the touches.

11-12. (canceled)

13. The in-vehicle operation device according to claim 1, further comprising:
a half mirror section having a reflecting surface and a transmitting surface and configured to reflect light incident on the reflecting surface and transmit light incident on the transmitting surface,
the display section being disposed on or over the half mirror section in such a manner that the transmitting surface faces the display surface.

14. The in-vehicle operation device according to claim 13, further comprising:
a display control section configured to cause the display section to display or hide the image in correspondence with the touch detected by the side-surface touch detecting section.

15. The in-vehicle operation device according to claim 13,
wherein
the display section has a curved portion or cutout portion on a periphery thereof;
the side-surface touch detecting section detects a touch by a user on at least a position on a portion of the side surface of the casing which portion extends along the curved portion or cutout portion of the display section.

16. The in-vehicle operation device according to claim 15,
wherein
the curved portion or cutout portion has a peripheral line that is curved enough for the user who has touched the position to perceive the position on a basis of feel.
